(19) United States
(12) Patent Application Publication
(10) Pub. No.: US 2010/0298976 A1
(43) Pub. Date: Nov. 25, 2010

(54) ROBOT CONTROL SYSTEM, ROBOT, PROGRAM, AND INFORMATION STORAGE MEDIUM

(75) Inventors: Ryohei Sugihara, Tokyo (JP); Seiji Tatsuta, Tokyo (JP); Yoichi Iba, Tokyo (JP); Nobuto Fukushima, Saitama (JP); Tsuneharu Kasai, Saitama (JP); Hideki Shimizu, Saitama (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/676,732

(22) PCT Filed: Sep. 1, 2008
(86) PCT No.: PCT/JP2008/065643

§ 371 Date: Aug. 9, 2010

(30) Foreign Application Priority Data
Sep. 6, 2007 (JP) 2007-231482

(51) Int. Cl. B25J 13/00

(52) U.S. Cl. 700/248; 700/258

(57) ABSTRACT

A robot control system includes a user information acquisition section (12) that acquires user information that is obtained based on sensor information from at least one of a behavior sensor that measures a behavior of a user, a condition sensor that measures a condition of the user, and an environment sensor that measures an environment of the user, a presentation information determination section (14) that determines presentation information that is presented to the user by the robot based on the acquired user information, and a robot control section (30) that controls the robot to present the presentation information to the user. The presentation information determination section (14) determines the presentation information that is presented to the user so that a first robot and a second robot present different types of presentation information based on the identical acquired user information.

### TECHNICAL FIELD

The present invention relates to a robot control system, a robot, a program, an information storage medium, and the like.

### BACKGROUND ART

A robot control system that recognizes the voice of the user (human) and implements a conversation with the user based on the voice recognition result has been known (JP-A-2003-66986, for example).

However, a related-art robot control system is configured on the assumption that one robot talks to one user. Therefore, since a complex algorithm is required for a voice recognition process and a conversational process, it has been difficult to implement a smooth conversation with the user.

When one robot talks to one user, the user may get stuck or lose interest in the conversation with the robot.

Moreover, a related-art robot control system does not control the robot while reflecting the behavior of the user during the day, or the past or current condition of the user. Therefore, the robot may perform an operation that is not appropriate for the mental state or the condition of the user.

### DISCLOSURE OF THE INVENTION

Several aspects of the invention may provide a robot control system, a robot, a program, and an information storage medium that implement robot control that reflects the behavior or the condition of the user.

One aspect of the invention relates to a robot control system that controls a robot, the robot control system comprising: a user information acquisition section that acquires user information that is obtained based on sensor information from at least one of a behavior sensor that measures a behavior of a user, a condition sensor that measures a condition of the user, and an environment sensor that measures an environment of the user; a presentation information determination section that determines presentation information that is presented to the user by the robot based on the acquired user information; and a robot control section that controls the robot to present the presentation information to the user, the presentation information determination section determining the presentation information that is presented to the user so that a first robot and a second robot present different types of presentation information corresponding to the identical acquired user information. Another aspect of the invention relates to a program that causes a computer to function as each of the above sections, or a computer-readable information storage medium storing the program.

According to one aspect of the invention, the user information that is obtained based on the sensor information from at least one of the behavior sensor, the condition sensor, and the environment sensor is acquired. The presentation information that is presented to the user by the robot is determined based on the acquired user information, and the robot is controlled to present the presentation information. According to the invention, the presentation information is determined so that the first robot and the second robot present different types of presentation information based on the identical acquired user information. The user can be indirectly notified of the past or current behavior, condition, environment, etc. of the user based on the presentation information presented by the first robot and the second robot by determining the presentation information based on the user information. It is possible to indirectly prompt the user to become aware of something about the user based on the presentation information presented by the first robot and the second robot by causing the first robot and the second robot to present different types of presentation information based on the identical acquired user information.

In the robot control system according to one aspect of the invention, the first robot may be set as a master, and the second robot may be set as a slave; and the presentation information determination section that is provided in the master-side first robot may instruct the slave-side second robot to present the presentation information to the user.

Therefore, the presentation information can be presented using the first robot and the second robot under stable control (i.e., malfunctions rarely occur) without utilizing a complex presentation information analysis process.

The robot control system according to one aspect of the invention may further comprise a communication section that transmits instruction information from the master-side first robot to the slave-side second robot, the instruction information instructing presentation of the presentation information.

According to this configuration, since it suffices to transmit the instruction information instead of the presentation information, the amount of communication data can be reduced while simplifying the process.

In the robot control system according to one aspect of the invention, the user information acquisition section may acquire user historical information as the user information, the user historical information being at least one of a behavior history, a condition history, and an environment history of the user; and the presentation information determination section may determine the presentation information that is presented to the user by the robot based on the acquired use historical information.

This makes it possible to cause the first robot and the second robot to present the presentation information that reflects the past behavior history, condition history, or environment history of the user to indirectly prompt the user to become aware of his past behavior history, condition history, or environment history.

The robot control system according to one aspect of the invention may further comprise: an event determination section that determines occurrence of an available event that indicates that the robot is available, wherein the presentation information determination section may determine the presentation information presented to the user by the robot based on first user historical information acquired in a first period before the available event occurs and second user historical information acquired in a second period after the available event has occurred.

This makes it possible to provide the user with the presentation information that takes account of the behavior etc. of the user in the first period and the behavior etc. of the user in the second period.

In the robot control system according to one aspect of the invention, the presentation information determination section may change weighting of the first user historical information and weighting of the second user historical information when determining the presentation information in the second period.

This makes it possible to gradually change the information presented in the second period.

In the robot control system according to one aspect of the invention, the presentation information determination section may increase the weighting of the first user historical information while decreasing the weighting of the second user historical information when determining the presentation information when the available event has occurred, and then decrease the weighting of the first user historical information while increasing the weighting of the second user historical information.

This makes it possible to provide timely information corresponding to the behavior, the condition, etc. of the user.

In the robot control system according to one aspect of the invention, the user historical information may be information that is updated based on sensor information from a wearable sensor of the user.

This makes it possible to update the behavior history, the condition history, or the environment history based on the sensor information from the wearable sensor, and present the presentation information that reflects the behavior history, the condition history, or the environment history using the first robot and the second robot.

In the robot control system according to one aspect of the invention, the presentation information determination section may determine the presentation information that is subsequently presented to the user by the robot based on a reaction of the user to the presentation information that has been presented by the robot.

According to this configuration, the presentation information that is subsequently presented to the user changes based on the reaction of the user to the presentation information so that a situation in which presentation of the presentation information by the first robot and the second robot becomes monotonous can be prevented.

The robot control system according to one aspect of the invention may further comprise: a user characteristic information storage section that stores user characteristic information; and a user characteristic information update section that updates the user characteristic information based on the reaction of the user to the presentation information presented by the robot.

This makes it possible to update the user characteristic information while reflecting the reaction of the user to the presentation information.

The robot control system according to one aspect of the invention may further comprise: a contact state determination section that determines a contact state on a sensing surface of the robot, wherein the presentation information determination section may determine whether the user has stroked or hit the robot as the reaction of the user to the presentation information presented by the robot based on the determination result of the contact state determination section, and determine the presentation information that is subsequently presented to the user.

This makes it possible to determine the reaction (e.g., stroke operation or hit operation) of the user by a simple determination process.

In the robot control system according to one aspect of the invention, the contact state determination section may determine the contact state on the sensing surface based on output data obtained by performing a calculation process on an output signal from a microphone provided under the sensing surface.

This makes it possible to detect the reaction (e.g., stroke operation or hit operation) of the user by merely utilizing the microphone.

In the robot control system according to one aspect of the invention, the output data may be a signal strength; and the contact state determination section may compare the signal strength with a given threshold value to determine whether the user has stroked or hit the robot.

This makes it possible to determine whether the user has stroked or hit the robot by a simple process that compares the signal strength with the threshold value.

The robot control system according to one aspect of the invention may further comprise: a scenario data storage section that stores scenario data that includes a plurality of phrases as the presentation information, wherein the presentation information determination section may determine a phrase spoken to the user by the robot based on the scenario data; and the robot control section may cause the robot to speak the determined phrase.

This makes it possible to cause the first robot and the second robot to speak the phrases by a simple control process utilizing the scenario data.

In the robot control system according to one aspect of the invention, the scenario data storage section may store the scenario data in which a plurality of phrases are linked by a branched structure; and the presentation information determination section may determine a phrase that is subsequently spoken by the robot based on a reaction of the user to the phrase that has been spoken by the robot.

According to this configuration, the phrase that is subsequently spoken by the robot changes based on the reaction of the user to the phrase that has been spoken by the robot so that a situation in which a conversation between the first robot and the second robot becomes monotonous can be prevented.

In the robot control system according to one aspect of the invention, the presentation information determination section may select second scenario data that is different from first scenario data when the user has made a given reaction to a phrase that has been spoken by the robot based on the first scenario data, and determine the phrase that is subsequently spoken by the robot based on the second scenario data.

According to this configuration, the scenario changes based on the reaction of the user so that a conversation between the first robot and the second robot based on the scenario data appropriate for the preference etc. of the user can be implemented.

The robot control system according to one aspect of the invention may further comprise a speak right control section that determines whether to give a next phrase speak right to the first robot or the second robot based on a reaction of the user to the phrase spoken by the robot.

According to this configuration, since the phrase speak right is given based on the reaction of the user, a situation in which a conversation between the first robot and the second robot becomes monotonous can be prevented.

In the robot control system according to one aspect of the invention, the speak right control section may determine a robot to which the next phrase speak right is given, based on whether the user has made a positive reaction or a negative reaction to the phrase spoken by the first robot or the second robot.

This makes it possible to preferentially give the speak right to the robot for which the user has made a positive reaction.

The robot control system according to one aspect of the invention may further comprise a scenario data acquisition section that acquires scenario data selected from a plurality of pieces of scenario data based on the user information.

This makes it possible to acquire the scenario data based on the user information.

In the robot control system according to one aspect of the invention, the scenario data acquisition section may download the scenario data selected based on the user information through a network; and the presentation information determination section may determine the phrase spoken by the robot based on the scenario data downloaded through the network.

This makes it unnecessary to store all pieces of scenario data in the scenario data storage section so that the storage capacity can be saved.

In the robot control system according to one aspect of the invention, the scenario data acquisition section may acquire scenario data selected based on at least one of current date information, current place information about the user, current behavior information about the user, and current occasion information about the user; and the presentation information determination section may determine the phrase spoken by the robot based on the scenario data selected based on at least one of the current date information, the current place information about the user, the current behavior information about the user, and the current occasion information about the user.

This makes it possible to implement a conversation between the first robot and the second robot based on real-time user information.

In the robot, control system according to one aspect of the invention, the scenario data acquisition section may acquire scenario data selected based on at least one of behavior historical information about the user and condition historical information about the user; and the presentation information determination section may determine the phrase spoken by the robot based on the scenario data selected based on at least one of the behavior historical information about the user and the condition historical information about the user.

This makes it possible to implement a conversation between the first robot and the second robot based on the behavior historical information or the condition historical information about the user.

The robot control system according to one aspect of the invention may further comprise: a user characteristic information storage section that stores user characteristic information; and a user characteristic information update section that updates the user characteristic information based on a reaction of the user to the phrase spoken by the robot, wherein the scenario data acquisition section may acquire scenario data selected based on the user characteristic information.

This makes it possible to update the user characteristic information while reflecting the reaction of the user to the phrase spoken by the robot.

A further aspect of the invention relates to a robot comprising: the above robot control system; and a robot motion mechanism that is a control target of the robot control system.

### BRIEF DESCRIPTION OF THE DRAWINGS

FIG. 1 is a view illustrative of a user information acquisition method.

FIG. 2 shows a system configuration example according to one embodiment of the invention.

FIGS. 3A to 3C are views illustrative of a method according to one embodiment of the invention.

FIG. 4 is a flowchart illustrative of an operation according to one embodiment of the invention.

FIG. 5 shows a second system configuration example according to one embodiment of the invention.

FIG. 6 shows a third system configuration example according to one embodiment of the invention.

FIG. 7 shows a fourth system configuration example according to one embodiment of the invention.

FIG. 8 is a flowchart showing a user historical information update process.

FIG. 9 is a view illustrative of user historical information.

FIGS. 10A and 10B are views illustrative of user historical information.

FIG. 11 shows a detailed system configuration example according to one embodiment of the invention.

FIGS. 12A and 12B are views illustrative of a speak right control method.

FIGS. 13A and 13B are views illustrative of a speak right control method.

FIG. 14 is a flowchart illustrative of a detailed operation according to one embodiment of the invention.

FIG. 15 is a view illustrative of scenario data.

FIG. 16 is a view illustrative of a scenario branch method based on the reaction of the user.

FIG. 17 is a view illustrative of a scenario selection method based on the reaction of the user.

FIG. 18 is a view illustrative of a scenario selection method based on real-time user information.

FIG. 19 is a view illustrative of a scenario selection method based on real-time user information.

FIG. 20 is a view illustrative of a scenario selection method based on user historical information.

FIG. 21 is a view illustrative of a scenario selection method based on user historical information.

FIG. 22 is a view illustrative of a scenario selection method based on user characteristic information.

FIG. 23 is a view illustrative of a presentation information determination method based on user historical information.

FIG. 24 is a view illustrative of a presentation information determination process based on user historical information.

FIG. 25 shows examples of scenarios selected based on first user historical information and second user historical information.

FIGS. 26A and 26B are views illustrative of a contact determination method.

FIGS. 27A, 27B, and 27C show voice waveform examples when hitting a sensing surface, stroking a sensing surface, and speaking into a microphone.

### BEST MODE FOR CARRYING OUT THE INVENTION

Embodiments of the invention are described below. Note that the following embodiments do not in any way limit the scope of the invention laid out in the claims. Note that all elements of the following embodiments should not necessarily be taken as essential requirements for the invention.

1. User Information

As a ubiquitous service, a convenience provision service that aims at providing the user with necessary information anywhere and anytime has been proposed. The convenience provision service externally and unilaterally provides information to the user.

However, the convenience provision service that externally and unilaterally provides information to the user is insufficient for a person to enjoy an active and full life. Therefore, it is desirable to provide an inspiring ubiquitous service that inspires the user to be aware of something by appealing to the user's mind to promote personal growth of the user.

In this embodiment, user information is acquired based on sensor information from a behavior sensor, a condition sensor, and an environment sensor that respectively measure the behavior, the condition, and the environment of the user in order to implement an inspiring ubiquitous service by utilizing information that is presented to the user by a robot. Presentation information (e.g., conversation) that is presented to the user by a robot is determined based on the acquired user information, and the robot is controlled to present the determined presentation information to the user. A method of acquiring the user information (information about at least one of the behavior, the condition, and the environment of the user) is described below.

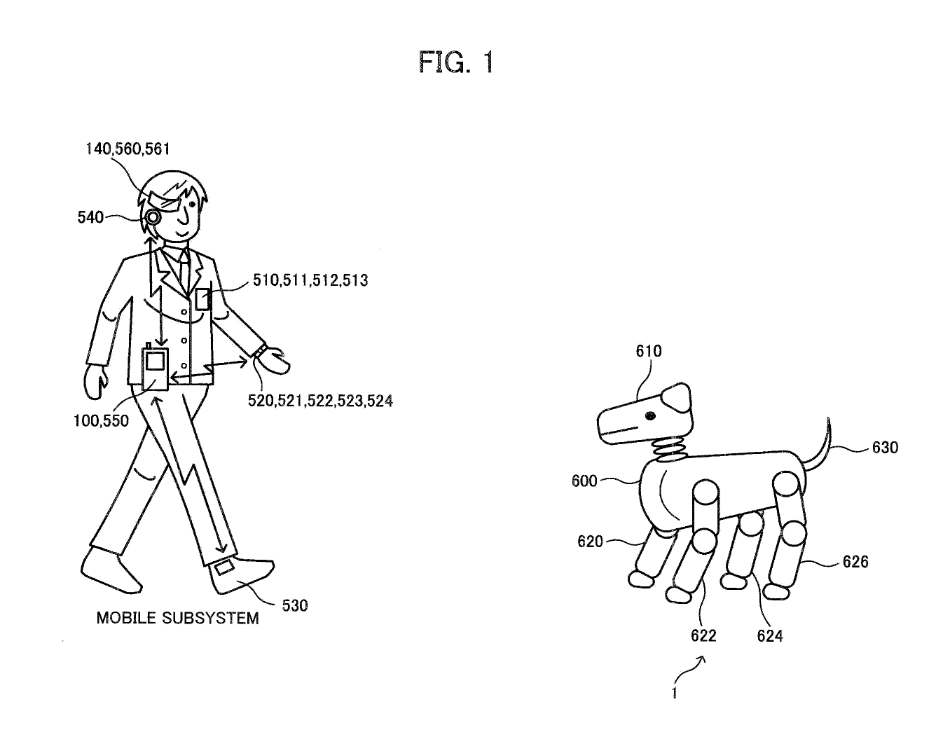

In FIG. 1, the user carries a portable electronic instrument 100 (mobile gateway). The user wears a wearable display 140 (mobile display) near one of the eyes as a mobile control target instrument. The user also wears various sensors as wearable sensors (mobile sensors). Specifically, the user wears an indoor/outdoor sensor 510, an ambient temperature sensor 511, an ambient humidity sensor 512, an ambient luminance sensor 513, a wrist-mounted movement measurement sensor 520, a pulse (heart rate) sensor 521, a body temperature sensor 522, a peripheral skin temperature sensor 523, a sweat sensor 524, a foot pressure sensor 530, a speech/mastication sensor 540, a Global Position System (GPS) sensor 550 provided in the portable electronic instrument 100, a complexion sensor 560 and a pupil sensor 561 provided in the wearable display 140, and the like. A mobile subsystem is formed by the portable electronic instrument 100, the mobile control target instruments such as the wearable display 140, and the wearable sensors.

In FIG. 1, user information (user historical information in a narrow sense) that is updated based on the sensor information from the sensors of the mobile subsystem of the user is acquired, and a robot 1 is controlled based on the acquired user information.

The portable electronic instrument 100 (mobile gateway) is a portable information terminal such as a personal digital assistant (PDA) or a notebook PC, and includes a processor (CPU), a memory, an operation panel, a communication device, a display (sub-display), and the like. The portable electronic instrument 100 may have a function of collecting sensor information from a sensor, a function of performing a calculation process based on the collected sensor information, a function of controlling (e.g., display control) the control target instrument (e.g., wearable display) or acquiring information from an external database based on the calculation results, a function of communicating with the outside, and the like. Note that the portable electronic instrument 100 may be an instrument that is used as a portable telephone, a wristwatch, a portable audio player, or the like.

The user wears the wearable display 140 near one of his eyes. The wearable display 140 is set so that the display section is smaller than the pupil, and functions as a see-through viewer information display section. Information may be presented (provided) to the user using a headphone, a vibrator, or the like. Examples of the mobile control target instrument other than the wearable display 140 include a wristwatch, a portable telephone, a portable audio player, and the like.

The indoor/outdoor sensor 510 detects whether the user stays in a room or stays outdoors. For example, the indoor/outdoor sensor emits ultrasonic waves, and measures the time required for the ultrasonic waves to be reflected by a ceiling or the like and return to the indoor/outdoor sensor. The indoor/outdoor sensor 510 is not limited to an ultrasonic sensor, but may be an active optical sensor, a passive ultraviolet sensor, a passive infrared sensor, or passive noise sensor.

The ambient temperature sensor 511 measures the ambient temperature using a thermistor, a radiation thermometer, a thermocouple, or the like. The ambient humidity sensor 512 measures the ambient humidity by utilizing a phenomenon in which an electrical resistance changes due to humidity, for example. The ambient luminance sensor 513 measures the ambient luminance using a photoelectric element, for example.

The wrist-mounted movement measurement sensor 520 measures the movement of the aim of the user using an acceleration sensor or an angular acceleration sensor. The daily performance and the walking state of the user can be more accurately measured using the movement measurement sensor 520 and the foot pressure sensor 530. The pulse (heart rate) sensor 521 is attached to the wrist, finger, or ear of the user, and measures a change in bloodstream due to pulsation based on a change in transmittance or reflectance of infrared light. The body temperature sensor 522 and the peripheral skin temperature sensor 523 measure the body temperature and the peripheral skin temperature of the user using a thermistor, a radiation thermometer, a thermocouple, or the like. The sweat sensor 524 measures skin perspiration based on a change in the surface resistance of the skin, for example. The foot pressure sensor 530 detects the distribution of pressure applied to the shoe, and determines that the user is in a standing state, a sitting state, a walking state, or the like.

The speech/mastication sensor 540 is an earphone-type sensor that measures the possibility that the user speaks (conversation) or masticates (eating). The speech/mastication sensor 540 includes a bone conduction microphone and an ambient sound microphone provided in a housing. The bone conduction microphone detects body sound that is a vibration that occurs from the body during speech/mastication and is propagated inside the body. The ambient sound microphone detects voice that is a vibration that is transmitted to the outside of the body due to speech, or ambient sound including environmental noise. The speech/mastication sensor 540 measures the possibility that the user speaks or masticates by comparing the power of the sound captured by the bone conduction microphone with the power of the sound captured by the ambient sound microphone per unit time, for example.

The GPS sensor 550 detects the position of the user. Note that a portable telephone position information service or peripheral wireless LAN position information may be utilized instead of the GPS sensor 550. The complexion sensor 560 includes an optical sensor disposed near the face, and compares the luminance of light through a plurality of optical band-pass filters to measure the complexion, for example. The pupil sensor 561 includes a camera disposed near the pupil, and analyzes a camera signal to measure the size of the pupil, for example.

In FIG. 1, the user information is acquired by the mobile subsystem formed by the portable electronic instrument 100, the wearable sensors, and the like. Note that the user information may be updated by an integrated system that includes a plurality of subsystems, and the robot 1 may be controlled based on the updated user information. The integrated system may include a mobile subsystem, a home subsystem, a car subsystem, a company subsystem, a store subsystem, and the like.

When the user stays outdoors (i.e., mobile environment), for example, the integrated system acquires (collects) the sensor information (including secondary sensor information) from the wearable sensors (mobile sensors) of the mobile subsystem, and updates the user information (user historical information) based on the acquired sensor information. The integrated system controls the mobile control target instrument based on the user information and the like.

When the user stays home (i.e., home environment), the integrated system acquires the sensor information from home sensors of the home subsystem, and updates the user information based on the acquired sensor information. Specifically, the user information that has been updated in the mobile environment is seamlessly updated in the home environment. The integrated system controls a home control target instrument (e.g., television, audio instrument, and air conditioner) based on the user information and the like. Examples of the home sensors include an environment sensor that measures the temperature, humidity, luminance, noise, conversation, meal times, etc. in the home, a robot-mounted sensor provided in a robot, a person detection sensor provided in each room, door, etc., a urine check sensor provided in a rest room, and the like.

When the user rides in a car (i.e., car environment), the integrated system acquires the sensor information from car sensors of the car subsystem, and updates the user information based on the acquired sensor information. Specifically, the user information that has been updated in the mobile environment or the home environment is seamlessly updated in the car environment. The integrated system controls a car control target instrument (e.g., navigation system, car AV instrument, and air conditioner) based on the user information and the like. Examples of the car sensors include a travel sensor that measure the speed, travel distance, etc. of the car, an operation sensor that measures the user's drive operation and instrument operation, an environment sensor that measures the temperature, humidity, luminance, conversation etc. in the car, and the like.

2. Robot

The configuration of the robot 1 (robot 2) shown in FIG. 1 is described below. The robot 1 is a pet-type robot that imitates a dog. The robot 1 includes a plurality of part modules (robot motion mechanisms) such as a body module 600, a head module 610, leg modules 620, 622, 624, 626, and a tail module 630.

The head module 610 includes a touch sensor that detects a stroke operation or a hit operation of the user, a speech sensor (microphone) that detects speech of the user, an image sensor (camera) for image recognition, and a sound output section (speaker) that outputs voice or a call.

A joint mechanism is provided between the body module 600 and the head module 610, between the body module 600 and the tail module 630, and at the joint of the leg module 620, for example. These joint mechanisms include an actuator such as a motor so that joint movement or self-travel of the robot 1 is implemented.

The body module 600 of the robot 1 includes one or more circuit boards, for example. The circuit board is provided with a CPU (processor) that performs various processes, a memory (e.g., ROM or RAM) that stores data and a program, a robot control IC, a sound generation module that generates a sound signal, a wireless module that implements wireless communication with the outside, and the like. A signal from each sensor mounted on the robot 1 is transmitted to the circuit board, and processed by the CPU and the like. The sound signal generated by the sound generation module is output to the sound output section (speaker) from the circuit board. A control signal from the control IC of the circuit board is output to the actuator (e.g., motor) provided in the joint mechanism so that joint movement or self-travel of the robot 1 is controlled.

3. Robot Control System

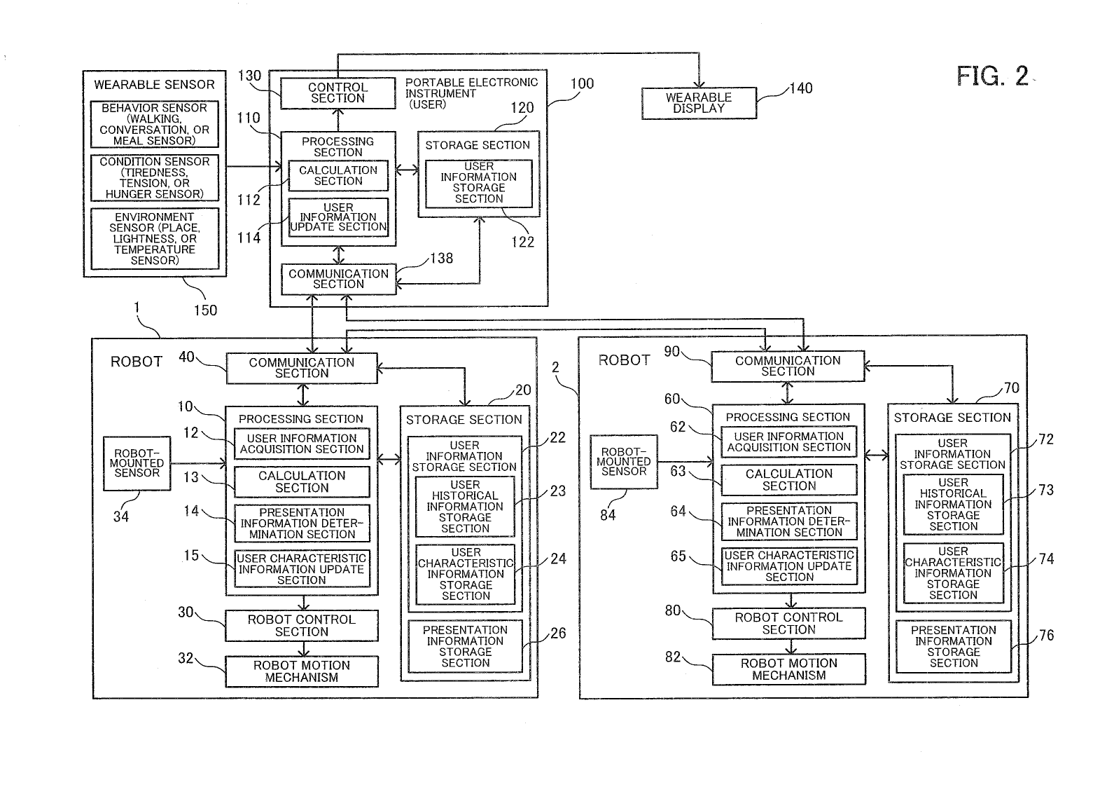

FIG. 2 shows a system configuration example according to this embodiment. The system shown in FIG. 2 includes the portable electronic instrument 100 carried by the user, and the robots 1 and 2 (first robot and second robot) that are controlled by the robot control system according to this embodiment. A robot control system according to this embodiment is implemented by processing sections 10 and 60 included in the robots 1 and 2, for example.

The portable electronic instrument 100 includes a processing section 110, a storage section 120, a control section 130, and a communication section 138. The portable electronic instrument 100 acquires sensor information from a wearable sensor 150. Specifically, the wearable sensor 150 includes at least one of a behavior sensor that measures the behavior (e.g., walk, conversation, meal, movement of hands and feet, emotion, or sleep) of the user, a condition sensor that measures the condition (e.g., tiredness, tension, hunger, mental state, physical condition, or event that has occurred) of the user, and an environment sensor that measures the environment (place, lightness, temperature, or humidity) of the user. The portable electronic instrument 100 acquires sensor information from these sensors.

Note that the sensor may be a sensor device, or may be a sensor instrument that includes a sensor device, a control section, a communication section, and the like. The sensor information may be primary sensor information that is directly obtained from the sensor, or may be secondary sensor information that is obtained by processing (information processing) the primary sensor information.

The processing section 110 performs various processes (e.g., a process required to operate the portable electronic instrument 100) based on operation information from an operation section (not shown), the sensor information acquired from the wearable sensor 150, and the like. The function of the processing section 110 may be implemented by hardware such as a processor (e.g., CPU) or an ASIC (e.g., gate array), a program stored in an information storage medium (e.g., optical disk, IC card, or HDD) (not shown), or the like.

The processing section 110 includes a calculation section 112 and a user information update section 114. The calculation section 112 performs various calculation processes for filtering (selecting) or analyzing the sensor information acquired from the wearable sensor 150. Specifically, the calculation section 112 performs a multiplication process or an addition process on the sensor information. For example, as shown by the following expression (1), digitized measured values Xⱼ of a plurality of pieces of sensor information from a plurality of sensors and each coefficient are stored in a coefficient storage section (not shown), and the calculation section 112 performs product-sum calculations on the measured values Xⱼ and coefficients Aᵢⱼ indicated by a two-dimensional matrix. As shown by the following expression (2), the calculation section 112 calculates the n-dimensional vector Yᵢ using the product-sum calculation results as multi-dimensional coordinates. Note that i is the i coordinate in the n-dimensional space, and j is a number assigned to each sensor.

$$\begin{matrix}( \begin{matrix}{Y}_{0} \\ {Y}_{1} \\ {Y}_{2} \\ ⋮ \\ {Y}_{i} \\ ⋮ \\ {Y}_{n}\end{matrix} ) = ( \begin{matrix}{A}_{00} & … & … & … & {A}_{0 m} \\ ⋮ & & & & ⋮ \\ ⋮ & & {A}_{ij} & & ⋮ \\ ⋮ & & & & ⋮ \\ {A}_{n 0} & … & … & … & {A}_{n m}\end{matrix} ) ( \begin{matrix}{X}_{0} \\ {X}_{1} \\ {X}_{2} \\ ⋮ \\ {X}_{j} \\ ⋮ \\ {X}_{m}\end{matrix} ) & ( 1 ) \\ {Y}_{i} = {A}_{00} {X}_{0} + … + {A}_{ij} {X}_{j} … + {A}_{n m} {X}_{m} & ( 2 )\end{matrix}$$

A filtering process that removes unnecessary sensor information from the acquired sensor information, an analysis process that determines the behavior, the condition, and the environment (TPO information) of the user based on the sensor information, and the like can be implemented by performing the calculation process shown by the expressions (1) and (2). For example, if the coefficients A that are multiplied by the pulse (heart rate), perspiration amount, and body temperature measured values X are set to be larger than the coefficients that are multiplied by other sensor information measured values, the value Y calculated by the expressions (1) and (2) indicates the excitement level (condition) of the user. It is also possible to determine whether the user is seated and talks, talks while walking, thinks quietly, or sleeps by appropriately setting the coefficient that is multiplied by the speech measured value X and the coefficient that is multiplied by the foot pressure measured value X.

The user information update section 114 updates the user information (user historical information). Specifically, the user information update section 114 updates the user information based on the sensor information acquired from the wearable sensor 150. The user information update section 114 stores the updated user information (user historical information) in a user information storage section 122 (user historical information storage section) of the storage section 120. In order to save the memory capacity of the user information storage section 122, old user information may be deleted when storing new user information, and the new user information may be stored in the storage area in which the old user information has been stored. Alternatively, an order of priority (weighting coefficient) may be assigned to each piece of user information, and the user information with a lower order of priority may be deleted when storing new user information. The user information may be updated (overwritten) by performing calculations on the user information that has been stored and the new user information.

The storage section 120 serves as a work area for the processing section 110, the communication section 138, and the like. The function of the storage section 120 may be implemented by a memory (e.g., RAM), a hard disk drive (HDD), or the like. A user information storage section 122 included in the storage section 120 stores the user information (user historical information) that is information (historical information) about the behavior, condition, environment, etc. of the user and is updated based on the acquired sensor information.

The control section 130 controls the wearable display 140 and the like. The communication section 138 transmits and receives information (e.g., user information) to and from a communication section 40 of the robot 1 and a communication section 90 of the robot 2 via wireless or cable communication. As wireless communication, short-distance wireless communication utilizing Bluetooth (registered trademark) or infrared radiation, a wireless LAN, or the like may be used. As cable communication, communication utilizing USB, IEEE 1394, or the like may be used.

The robot 1 includes a processing section 10, a storage section 20, a robot control section 30, a robot motion mechanism 32, a robot-mounted sensor 34, and the communication section 40. Note that the robot 1 may have a configuration in which some of these sections are omitted.

The processing section 10 performs various processes (e.g., a process that causes the robot 1 to operate) based on sensor information from the robot-mounted sensor 34, the acquired user information, and the like. The function of the processing section 10 may be implemented by hardware such as a processor (e.g., CPU) or an ASIC (e.g., gate array), a program stored in an information storage medium (e.g., optical disk, IC card, or HDD) (not shown), or the like. Specifically, the information storage medium stores a program that causes a computer (i.e., a device that includes an operation section, a processing section, a storage section, and an output section) to function as each section according to this embodiment (i.e., a program that causes a computer to execute the process of each section), and the processing section 10 performs various processes according to this embodiment based on the program (data) stored in the information storage medium.

The storage section 20 serves as a work area for the processing section 10, the communication section 40, and the like. The function of the storage section 20 may be implemented by a memory (e.g., RAM), a hard disk drive (HDD), or the like. The storage section 20 includes a user information storage section 22 and a presentation information storage section 26. The user information storage section 22 includes a user historical information storage section 23 and a user characteristic information storage section 24.

The robot control section 30 controls the robot motion mechanism 32 (e.g., actuator, sound output section, or LED) (control target). The function of the robot control section 30 may be implemented by hardware such as a robot control ASIC or a processor, a program, or the like.

Specifically, the robot control section 30 causes the robot to present the presentation information to the user. When the presentation information indicates a conversation (scenario data) of the robot, the robot control section 30 causes the robot to speak a phrase. For example, the robot control section 30 converts digital text data that indicates the phrase into an analog sound signal by a text-to-speech (TTS) process, and outputs the sound through a sound output section (speaker) of the robot motion mechanism 32. When the presentation information indicates the emotional state of the robot, the robot control section 30 controls an actuator of each joint mechanism of the robot motion mechanism 32, or causes the LED to be turned ON, for example.

The robot-mounted sensor 34 is a touch sensor, a speech sensor (microphone), an imaging sensor (camera), or the like. The robot 1 can monitor the reaction of the user to the information presented to the user based on the sensor information from the robot-mounted sensor 34.

The communication section 40 transmits and receives information (e.g., user information) to and from the communication section 138 of the portable electronic instrument 100 and the communication section 90 of the robot 2 via wireless or cable communication.

The processing section 10 includes a user information acquisition section 12, a calculation section 13, a presentation information determination section 14, and a user characteristic information update section 15. Note that the processing section 10 may have a configuration in which some of these sections are omitted.

The user information acquisition section 12 acquires the user information based on the sensor information from at least one of the behavior sensor that measures the behavior of the user, the condition sensor that measures the condition of the user, and the environment sensor that measures the environment of the user.

Specifically, when the user whose user information has been updated by the sensor information from the wearable sensor 150 has returned home and approached the robot 1 or 2, or connected the portable electronic instrument 100 to a cradle, the robots 1 and 2 are activated. The user information (user historical information) updated by the portable electronic instrument 100 is transferred to the user information storage section 22 (user information storage section 72) of the robot 1 (robot 2) from the user information storage section 122 of the portable electronic instrument 100 through the communication sections 138 and 40 (communication section 90). The user information acquisition section 12 (user information acquisition section 62) reads the transferred user information from the user information storage section 22 to acquire the user information. Note that the user information acquisition section 12 may directly acquire the user information from the portable electronic instrument 100 instead of reading the user information from the user information storage section 22.

The calculation section 13 performs a calculation process on the acquired user information. Specifically, the calculation section 13 performs an analysis process or a filtering process on the user information, if necessary. When the user information is the primary sensor information or the like, the calculation section 13 performs the calculation process shown by the expressions (1) and (2) to implement a filtering process that removes unnecessary sensor information from the acquired sensor information, an analysis process that determines the behavior, the condition, and the environment (TPO information) of the user based on the sensor information, and the like.

The presentation information determination section 14 determines the presentation information (conversation, emotional expression, and behavioral expression) that is presented (provided) to the user by the robot based on the acquired user information (user information subjected to the calculation process). Specifically, the presentation information determination section 14 determines the presentation information presented to the user so that the robots 1 and 2 present different types of presentation information (different phrases, different emotional expressions, or different behavioral expressions) based on the identical acquired user information. For example, the presentation information determination section 14 determines the presentation information so that the robot 1 presents first presentation information and the robot 2 presents second presentation information that differs from the first presentation information corresponding to the acquired user information.

When the user information acquisition section 12 has acquired the user historical information (i.e., at least one of the behavior history, condition history, and environment history of the user) as the user information, the presentation information determination section 14 determines the presentation information that is presented to the user by the robot based on the acquired user historical information. The user historical information is obtained by the update process performed by the portable electronic instrument 10 or the like based on the sensor information from the wearable sensor 150 of the user, and is transferred to the user historical information storage section 23 (user historical information storage section 73) of the robot 1 (robot 2) from the user information storage section 122 of the portable electronic instrument 100. The behavior history, condition history, and environment history of the user may be information (log information) that stores the behavior (e.g., walking, speech, or meal), the condition (e.g., tiredness, tension, hungry, mental condition, or physical condition), and the environment (e.g., place, brightness, or temperature) of the user that are linked to the date and the like.

The presentation information determination section 14 determines the presentation information that is subsequently presented to the user by the robot based on the reaction of the user to the presentation information that has been presented by the robot. Specifically, when the robot 1 has presented the presentation information to the user and the user has reacted to the presentation information, the reaction of the user is detected by the robot-mounted sensor 34. The presentation information determination section 14 determines (estimates) the reaction of the user based on the sensor information from the robot-mounted sensor 34, and determines the presentation information that is subsequently presented to the user.

The user characteristic information update section 15 updates user characteristic information. The updated user characteristic information is stored in the user characteristic information storage section 26 (user characteristic database) of the storage section 20. Specifically, the user characteristic information update section 15 updates the user characteristic information (reaction historical information) based on the reaction of the user to the presentation information presented by the robot.

The user characteristic information is information (user sensibility model data) that indicates the favorite and the taste of the user. In this embodiment, the robot presents the presentation information used to determine the favorite (e.g., sport or team) and the taste (e.g., color or music) of the user, for example. The robot learns the tendencies of the favorite and the taste of the user based on the reaction of the user to the presentation information to construct the user characteristic information that is a user sensibility model database.

The configuration of the robot 2 is the same as that of the robot 1. Therefore, description thereof is omitted.

4. Operation

An operation according to this embodiment is described below. A conversation between the user and the robot is normally implemented by a one-to-one relationship (e.g., one user and one robot).

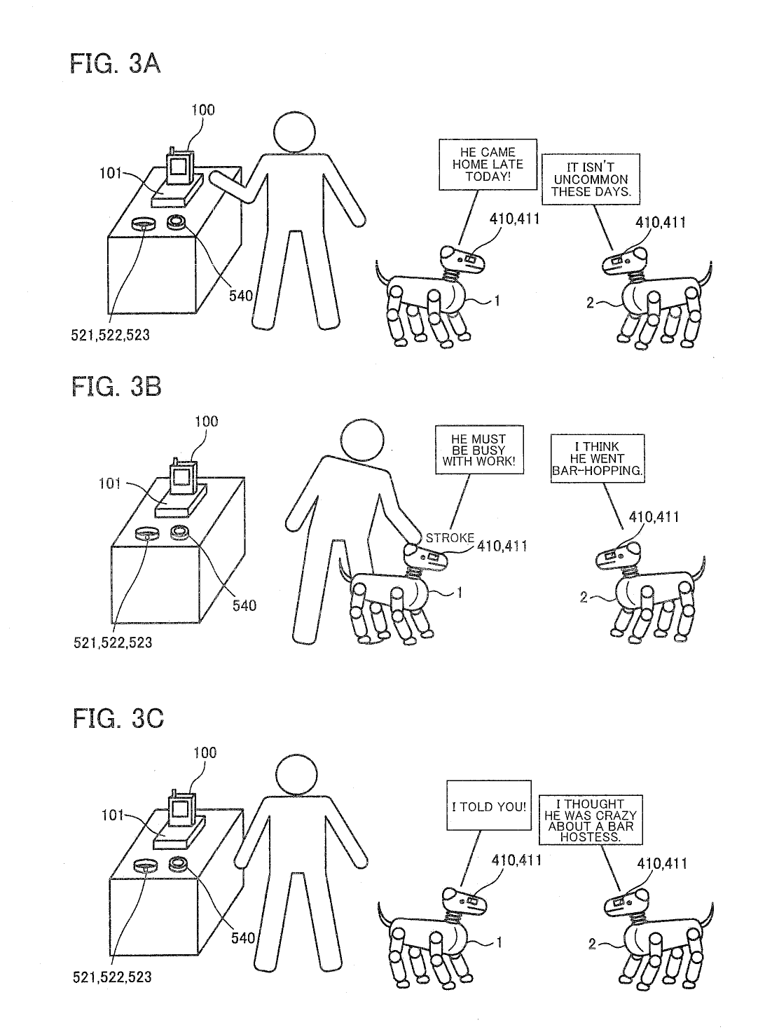

In this embodiment, however, two robots 1 and 2 (a plurality of robots in a broad sense) are provided for one user, and a conversation is implemented by a one-to-two (one-to-N in a broad sense) relationship, as shown in FIG. 3A. The user listens to a conversation between the robots 1 and 2 instead of directly having a conversation with the robots 1 and 2.

In this case, the information presented to the user through a conversation between the robots 1 and 2 is based on the user information acquired based on the sensor information from the behavior sensor, the condition sensor, and the environment sensor included in the wearable sensor 15 or the like. Therefore, the user can be indirectly notified of the past or current behavior of the user, the past or current condition of the user, and the past or current environment that surrounds the user through a conversation between the robots 1 and 2.

This makes it possible to implement an inspiring ubiquitous service that appeals to the user's mind through a conversation between the robots 1 and 2 to prompt the user to become aware of the behavior, condition, and environment of the user for further personal growth, instead of a convenience provision service that externally and unilaterally presents information to the user.

In FIG. 3A, the user who has returned home has connected the portable electronic instrument 100 to a cradle 101 to charge the portable electronic instrument 100, for example. In FIG. 3A, when the portable electronic instrument 100 has been connected to the cradle 101, the robot control system determines that an event that makes the robots 1 and 2 available has occurred, and activates the robots 1 and 2. Note that the robot control system may activate the robots 1 and 2 when the robot control system has determined that the user has approached the robots 1 and 2 instead of connection of the portable electronic instrument 100 to the cradle 101. For example, when information is transferred between the portable electronic instrument 100 and the robots 1 and 2 via wireless communication, occurrence of an event that makes the robots 1 and 2 available may be determined by detecting the radio signal strength.

When an event that makes the robots 1 and 2 available has occurred, the robots 1 and 2 are activated and can be utilized. The user information that has been updated in the mobile environment is stored in the user information storage section 122 of the portable electronic instrument 100. In FIG. 3, when an event that makes the robots 1 and 2 available has occurred, the user information stored in the user information storage section 122 is transferred to the user information storage sections 22 and 72 of the robots 1 and 2. This makes it possible to control the robots 1 and 2 based on the user information that has been updated in the mobile environment.

In FIG. 3A, it is determined that the user has returned home later than usual based on the user information, for example. Specifically, the time when the user returns home (“return home time”) is measured every day based on the place information from the GPS sensor of the wearable sensor 150 and the time information from a timer. The average return home time in the past is compared with the current return home time, and the presentation information regarding the return home time of the user is presented by the robots 1 and 2 when it has been determined that the user has returned home later than usual. Specifically, scenario data regarding the return home time of the user is selected, and the robots 1 and 2 start a conversation based on the selected scenario data. In FIG. 3A, the robot 1 speaks a phrase “He came home late today!”, and the robot 2 speaks a phrase “It isn't uncommon these days”, for example.

In this case, the presentation information that is presented the user by the robots 1 and 2 is determined so that the robots 1 and 2 present different types of presentation information corresponding to the user information that indicates that the user has returned home later than usual. In FIG. 3B, the robot 1 speaks a phrase “He must be busy with work!” that is positive to the user who has returned home late. On the other hand, the robot 2 speaks a phrase “I think he went bar-hopping” that is negative to the user.

For example, if the robot necessarily speaks a phrase that is either positive or negative to the user, the user may lose interest or get stuck in the conversation with the robot.

In FIG. 3B, however, the robots 1 and 2 speak phrases that make a contrast with each other. Moreover, the robots 1 and 2 have a conversation instead of directly talking to the user, and the user listens to the conversation between the robots 1 and 2. This makes it possible to provide an inspiring ubiquitous service that prompts the user to become aware of something through the conversation between the robots 1 and 2, instead of a convenience provision service.

In FIG. 3B, the user strokes the robot 1 that has spoken the phrase “He must be busy with work!”, since the user was busy with work and could not come home as usual. The stroke operation (i.e., the reaction of the user to the phrases spoken by the robots 1 and 2 (presentation of the presentation information)) of the user is detected by a touch sensor 410 of the robot 1 (or a contact state determination method or a speech sensor 411 described later).

Phrases subsequently spoken by the robots 1 and 2 (i.e., presentation information subsequently presented to the user) are then determined based on the reaction (i.e., stroke operation) of the user. As shown in FIG. 3C, the robot 1 that has been stroked by the user speaks “I told you!” since the opinion of the robot 1 has been affirmed, and the robot 2 speaks “I thought he was crazy about a bar hostess”. The robots 1 and 2 then have a conversation based on a scenario regarding the work of the user.

When the user has performed a stroke operation (see FIG. 3B), the stroke operation is stored as user reaction historical information, and the database stored in the user characteristic information storage section 24 is updated. For example, the user is determined to be a type of person who gives priority to work rather than bar-hopping based on the reaction of the user shown in FIG. 3B. Therefore, a work orientation parameter of the user characteristic information is increased to update the user characteristic information (sensibility database), for example. When selecting the scenario data that is subsequently provided to the user, scenario data that relates to work is preferentially selected taking account of the user characteristic information.

For example, it is difficult to estimate the favorite and the taste of the user based on only the sensor information from the wearable sensor 150. Specifically, it is difficult to determine whether the user gives priority to work rather than his hobby or determine the favorite color of the user based on only the sensor information from the behavior sensor and the like, for example. This makes it necessary to inquire of the user about his favorite and taste by means of a questionnaire, for example.

In FIG. 3B, however, the robots 1 and 2 speak phrases that make a contrast with each other, and the user characteristic information is updated based on the reaction of the user to the conversation between the robots 1 and 2. Therefore, whether the user gives priority to work or a hobby, or the favorite color of the user can be easily determined, and reflected in the user characteristic information, for example.

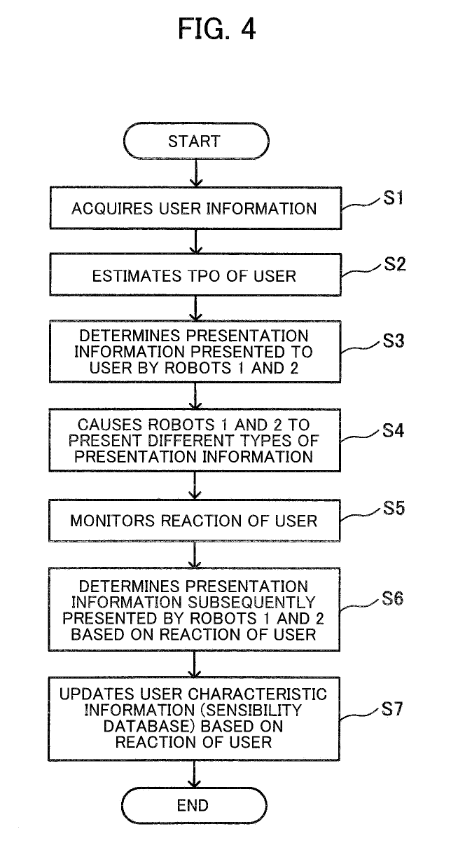

FIG. 4 is a flowchart illustrative of the operation according to this embodiment.

The user information acquisition section 12 acquires the user information obtained based on the sensor information from the behavior sensor and the like (step S1). Specifically, the user information is transferred from the portable electronic instrument 100 to the user information storage section 22, and the user information acquisition section 12 reads the user information from the user information storage section 22.

The TPO of the user is then estimated based on the user information, if necessary (step S2). The TPO (time, place, and occasion) information is at least one of time information (e.g., year, month, week, day, and time), place information (e.g., place, position, and distance) about the user, and condition information (e.g., mental/physical condition and event that has occurred for the user). For example, the meaning of latitude/longitude information obtained by the GPS sensor differs depending on the user. If the latitude and the longitude indicate the home of the user, the user is estimated to stay at home.

The presentation information presented to the user by the robots 1 and 2 is determined based on the user information and the TPO information, and the robots 1 and 2 are caused to present different types of presentation information (robot control) (steps S3 and S4). Specifically, phrases spoken by the robots 1 and 2 are determined, and the robots 1 and 2 are caused to speak the determined phrases, as described with reference to FIGS. 3A to 3C.

The reaction of the user to the presentation information presented in the step S4 is monitored (step S5). For example, whether the user has stroked the robot 1 or 2, has hit the robot 1 or 2, or has done nothing is determined. The presentation information that is subsequently presented to the user by the robots 1 and 2 is determined based on the reaction of the user that has been monitored (step S6).

Specifically, phrases that are subsequently spoken by the robots 1 and 2 are determined. The user characteristic information (sensibility database) is then updated based on the reaction of the user (step S7).

5. System Configuration Example

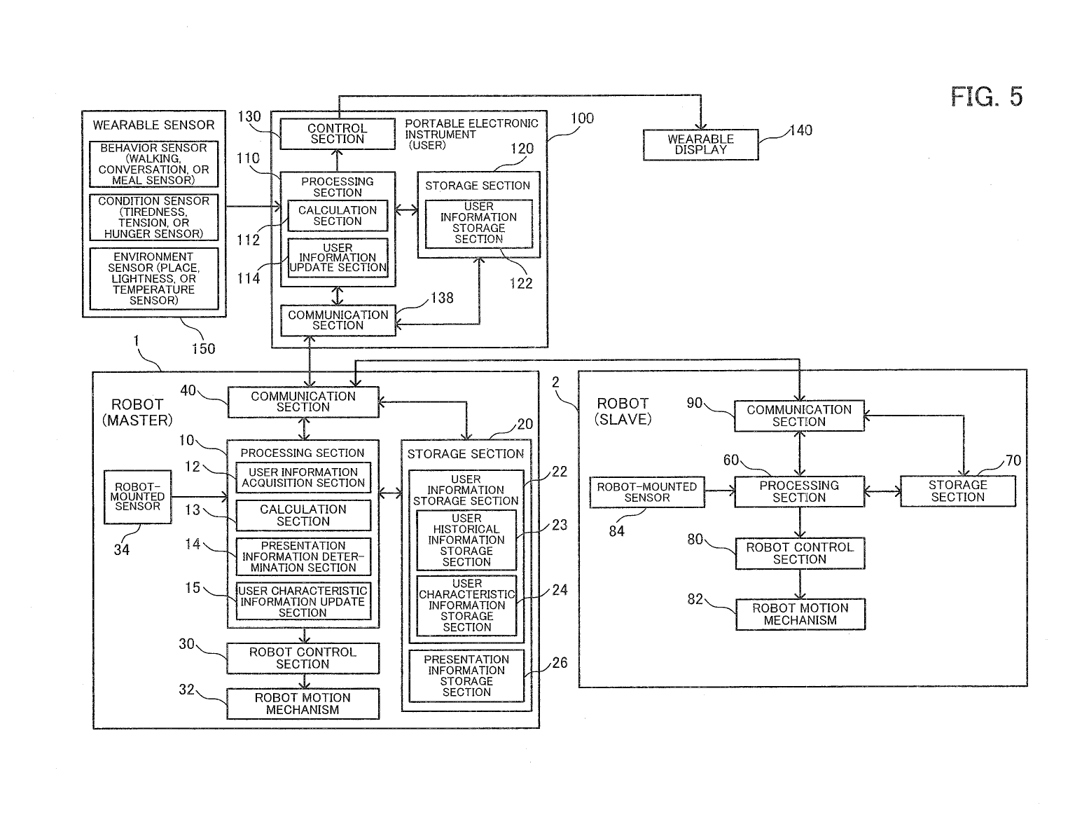

Various system configuration examples according to this embodiment are described in detail below. FIG. 5 shows a second system configuration example according to this embodiment. In FIG. 5, the robot 1 is set as a master, and the robot 2 is set as a slave. The robot control system according to this embodiment is mainly implemented by the processing section 10 of the master-side robot 1.

Specifically, the user information acquisition section 12 of the master-side robot 1 acquires the user information, and the master-side presentation information determination section 14 determines the presentation information that is presented to the user by the robots 1 and 2 based on the acquired user information. For example, when the presentation information determination section 14 has determined that the master-side robot 1 presents first presentation information and the slave-side robot presents second presentation information, the master-side robot control section 30 causes the robot 1 to present the first presentation information. The master-side robot 1 is thus controlled. The master-side presentation information determination section 14 instructs the slave-side robot 2 to present presentation information to the user. For example, when the master-side robot 1 presents first presentation information and the slave-side robot 2 presents second presentation information, the master-side presentation information determination section 14 instructs the slave-side robot 2 to present the second presentation information. The slave-side robot control section 80 then causes the robot 2 to present the second presentation information. The slave-side robot 2 is thus controlled.

In this case, the communication section 40 transmits instruction information that instructs the slave-side robot 2 to present the presentation information from the master-side robot 1 to the slave-side robot 2 via wireless communication or the like. When the slave-side communication section 90 has received the instruction information, the slave-side robot control section 80 causes the robot 2 to present the presentation information indicated by the instruction information.

The presentation information instruction information is an identification code of the presentation information, for example. When the presentation information indicates a phrase in a scenario, the instruction information is a data code of the phrase in the scenario.

For example, when the robots 1 and 2 have a conversation, the robot 2 may identify the phrase spoken by the robot 1 by voice recognition, and speak a phrase based on the voice recognition result.

However, this method requires a complex voice recognition/analysis process so that an increase in cost of the robot and complexity of the process, a malfunction, and the like may occur.

In FIG. 5, a conversation between the robots 1 and 2 is implemented under control of the master-side robot 1. Specifically, although the user observes a situation in which the robots 1 and 2 have a conversation while recognizing words spoken by the other, the robots 1 and 2 actually have a conversation under control of the master-side robot 1. Since the slave-side robot 2 determines the presentation information based on the instruction information transmitted from the master-side robot 1, it is unnecessary to utilize a voice recognition process. Therefore, a conversation between the robots 1 and 2 can be implemented under stable control (i.e., malfunctions rarely occur) without utilizing a complex voice recognition process or the like.

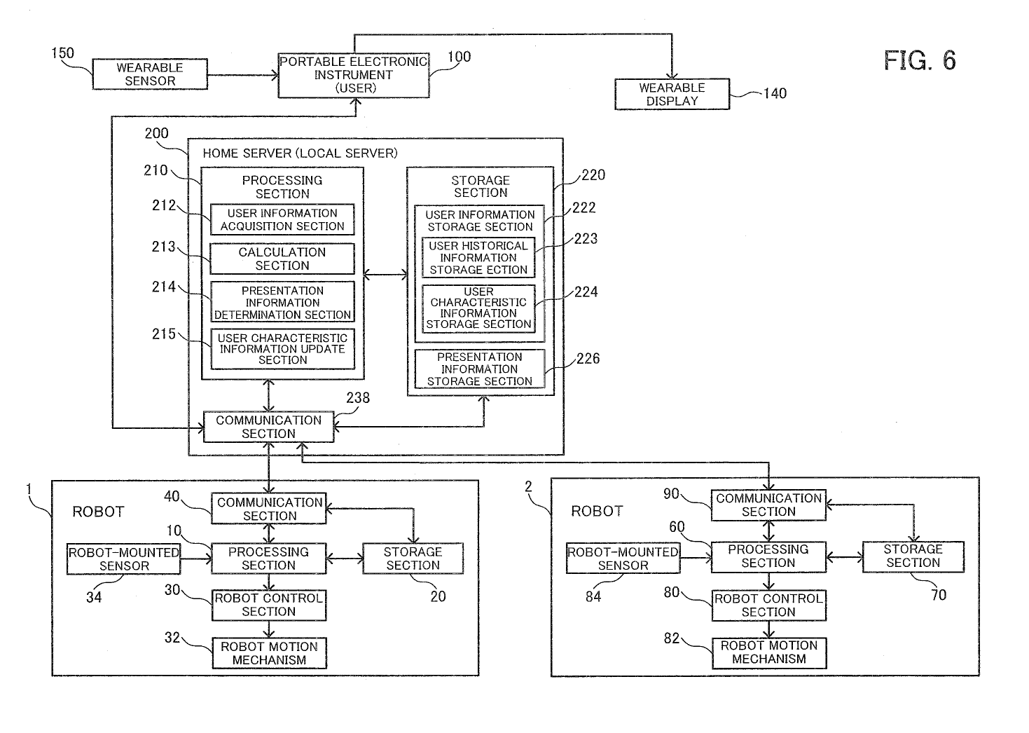

FIG. 6 shows a third system configuration example according to this embodiment. In FIG. 6, a home server (local server) 200 is provided. The home server 200 controls a control target instrument of a home subsystem, or communicates with the outside, for example. The robots 1 and 2 operate under control of the home server 200.

In the system shown in FIG. 6, the portable electronic instrument 100 and the home server 200 are connected via a wireless LAN, a cradle, or the like, and the home server 200 and the robots 1 and 2 are connected via a wireless LAN or the like. The robot control system according to this embodiment is mainly implemented by the processing section 210 of the home server 200. Note that the process of the robot control system may be implemented by distributed processing of the home server 200 and the robots 1 and 2.

When the user who carries the portable electronic instrument 100 has approached home, the portable electronic instrument 100 can communicate with the home server 200 via a wireless LAN or the like. Alternatively, the portable electronic instrument 100 can communicate with the home server 200 when the user has placed the portable electronic instrument 100 on the cradle.

When a communication path has been established, the user information is transferred from the portable electronic instrument 100 to a user information storage section 222 of the home server 200. A user information acquisition section 212 of the home server 200 then acquires the user information. A calculation section 213 performs necessary calculation processes, and a presentation information determination section 214 determines the presentation information that is presented to the user by the robots 1 and 2. The presentation information or the presentation information instruction information (e.g., phrase speech instruction information) is transmitted from a communication section 238 of the home server 200 to the communication sections 40 and 90 of the robots 1 and 2. The robot control sections 30 and 80 of the robots 1 and 2 present the received presentation information or the presentation information indicated by the received instruction information to the user. A user characteristic information update section 215 of the home server 200 updates the user characteristic information based on the reaction of the user.

According to the configuration shown in FIG. 6, since the robots 1 and 2 need not have a storage section that stores the user information and the presentation information when the user information and the presentation information (scenario data) have a large data size, for example, the cost and the size of the robots 1 and 2 can be reduced. Moreover, since the process of transferring and calculating the user information and the presentation information can be performed and managed by the home server 200, more intelligent robot control can be implemented.

According to the system shown in FIG. 6, the user information can be transferred from the portable electronic instrument 100 to the user information storage section 222 of the home server 200 before an event that makes the robots 1 and 2 available occurs. For example, the user information that has been updated in the mobile environment is transferred to and written the user information storage section 222 of the home server 200 before the user who returns home approaches the robots 1 and 2 (e.g., when the information from the GPS sensor (i.e., wearable sensor 150) worn by the user indicates that the user has arrived at the nearest station, or when the information from the door sensor (i.e., home sensor) indicates that the user has opened the front door). When the user who has approached the robots 1 and 2 (i.e., an event that makes the robots 1 and 2 available has occurred), the robots 1 and 2 are controlled based on the user information transferred in advance to the user information storage section 222. Specifically, the robots 1 and 2 are activated and caused to have a conversation shown in FIGS. 3A to 3C, for example. According to this configuration, a conversation based on the user information can be started immediately after activating the robots 1 and 2 so that the control efficiency can be improved.

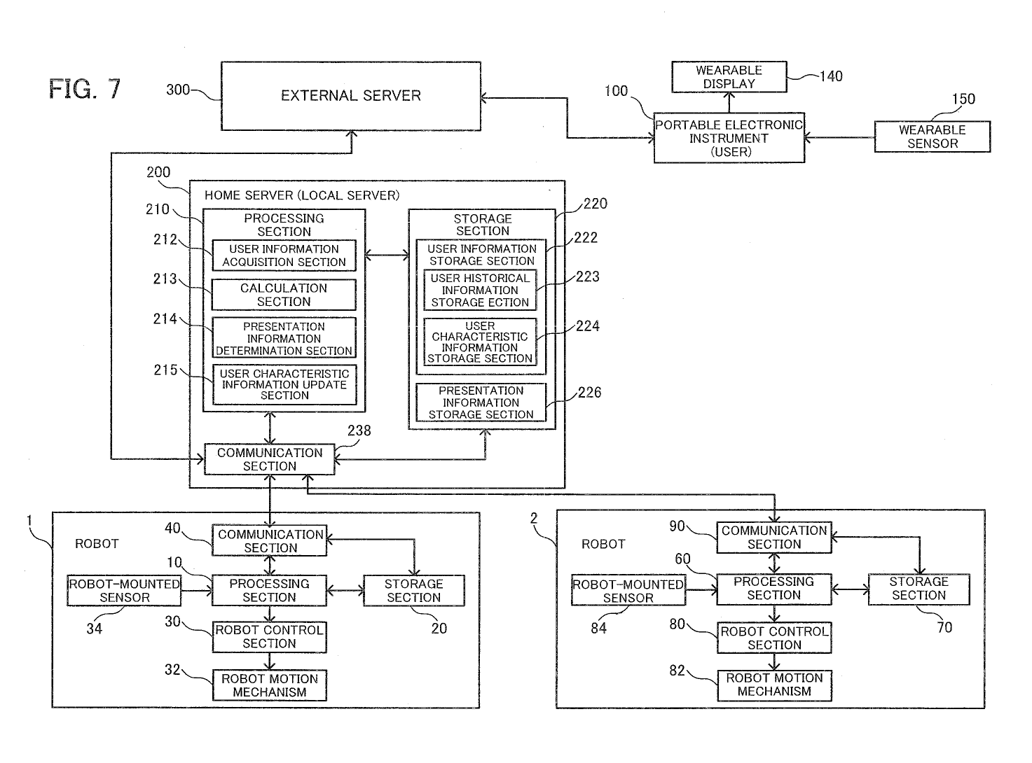

FIG. 7 shows a fourth system configuration example according to this embodiment. In FIG. 7, an external server (main server) 300 is provided. The external server 300 communicates with the portable electronic instrument 100 and the home server 200, and performs various control processes.

In the system shown in FIG. 7, the portable electronic instrument 100 and the external server 300 are connected via a wireless WAN (e.g., PHS), the external server 300 and the home server 200 are connected via a cable LAN (e.g., ADSL), and the home server 200 and the robots 1 and 2 are connected via a wireless LAN or the like. The robot control system according to this embodiment is mainly implemented by the processing section 210 of the home server 200 and a processing section (not shown) of the external server 300. Note that the process of the robot control system may be implemented by distributed processing of the home server 200, the external server 300, and the robots 1 and 2.

Each unit (e.g., portable electronic instrument 100 and home server 200) appropriately communicates with the external server 300, and transfers the user information. Whether or not the user has approached home is determined by utilizing the PHS position registration information, GPS sensor, microphone, and the like. When the user has approached home, the user information stored in a user information storage section (not shown) of the external server 300 is downloaded to the user information storage section 222 of the home server 200, and the robots 1 and 2 are controlled to present the presentation information. Scenario data described later and the like may also be downloaded from the external server 300 to a presentation information storage section 226 of the home server 200.

According to the system shown in FIG. 7, the user information and the presentation information can be integrally managed using the external server 300.

6. User Historical Information

A process of updating the user historical information (i.e., user information) and a specific example of the user historical information are described below. The user information may include user information that is obtained in real time based on the sensor information, user historical information that indicates the history of the user information that is obtained in real time based on the sensor information, and the like.

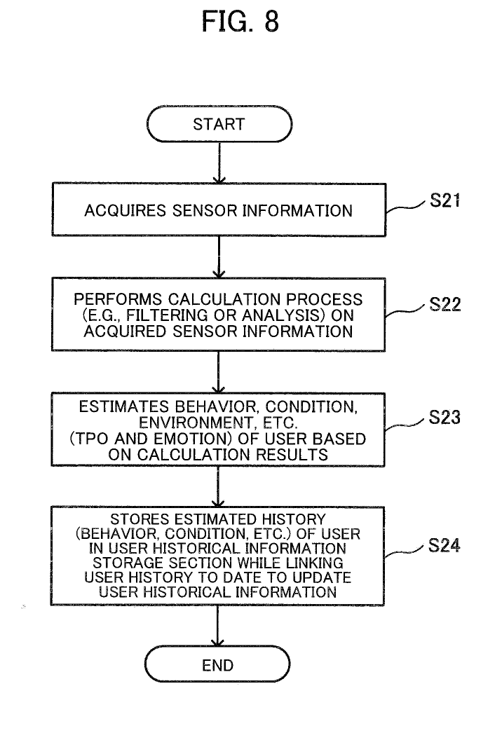

FIG. 8 is a flowchart showing an example of a user historical information update process.

The sensor information from the wearable sensor 150 and the like is acquired (step S21). A calculation process (e.g., filtering or analysis) is performed on the acquired sensor information (step S22). The behavior, condition, environment, etc. (TPO and emotion) of the user are estimated based on the calculation results (step S23). The estimated history (behavior, condition, etc.) of the user is stored in the user historical information storage section 23 (223) while linking the user history to the date (year, month, week, day, and time) to update the user historical information (step S24).

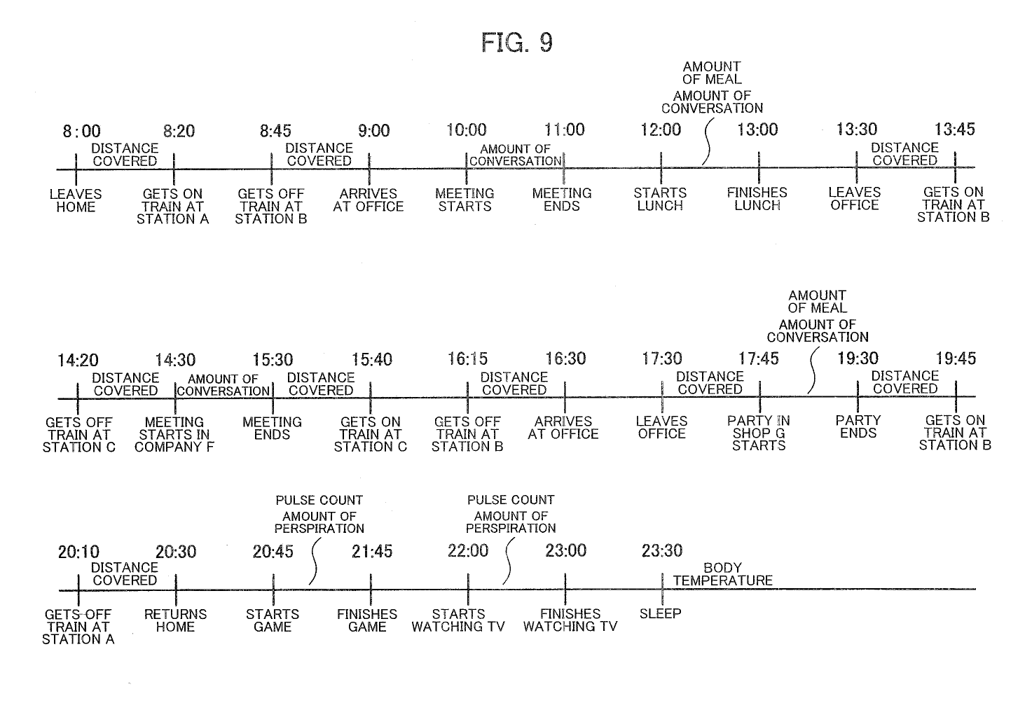

FIG. 9 schematically shows a specific example of the user historical information. The user historical information shown in FIG. 9 has a data structure in which the history (behavior etc.) of the user is linked to the time zone, time, etc. For example, the user leaves home at 8:00 AM, walks from home to the station in the time zone from 8:00 AM to 8:20 AM, and arrives at the nearest station A at 8:20 AM. The user takes a train in the time zone from 8:20 AM to 8:45 AM, gets off the train at a station B nearest to the office at 8:45 AM, arrives at the office at 9:00 AM, and starts working. The user holds a meeting with colleagues in the time zone from 10:00 AM to 11:00 AM, and has lunch in the time zone from 12:00 PM to 13:00 PM.

In FIG. 9, the user historical information is constructed by linking the history (behavior etc.) of the user estimated based on the sensor information and the like to the time zone, time, etc.

In FIG. 9, the values (e.g., amount of conversation, amount of meal, pulse count, and amount of perspiration) measured by the sensor and the like are also linked to the time zone, time, etc. For example, the user walks from home to the station A in the time zone from 8:00 AM to 8:20 AM. The distance covered by the user in the time zone is measured by the sensor, and linked to the time zone from 8:00 AM to 8:20 A.M. In this case, a measured value indicated by the sensor information other than the distance covered (e.g., walking speed and amount of perspiration) may be further linked to the time zone. This makes it possible to determine the amount of exercise of the user etc. in the time zone.

The user holds a meeting with colleagues in the time zone from 10:00 AM to 11:00 AM. The amount of conversation in the time zone is measured by the sensor, and linked to the time zone from 10:00 AM to 11:00 AM. In this case, a measured value indicated by sensor information (e.g., voice condition and pulse count) may be further linked to the time zone. This makes it possible to determine the amount of conversation and the tension level of the user in the time zone.

The user plays a game and watches a TV in the time zone from 20:45 to 21:45 and the time zone from 22:00 to 23:00. The pulse count and the amount of perspiration in these time zones are linked to these time zones. This makes it possible to determine the excitement level of the user etc. in these time zones.

The user sleeps in the time zone from 23:30. A change in body temperature of the user in the time zone is linked to the time zone. This makes it possible to determine the health condition of the user during sleep.

Note that the user historical information is not limited to that shown in FIG. 9. For example, the user historical information may be created without linking the history (behavior etc.) of the user to the date, time, etc.

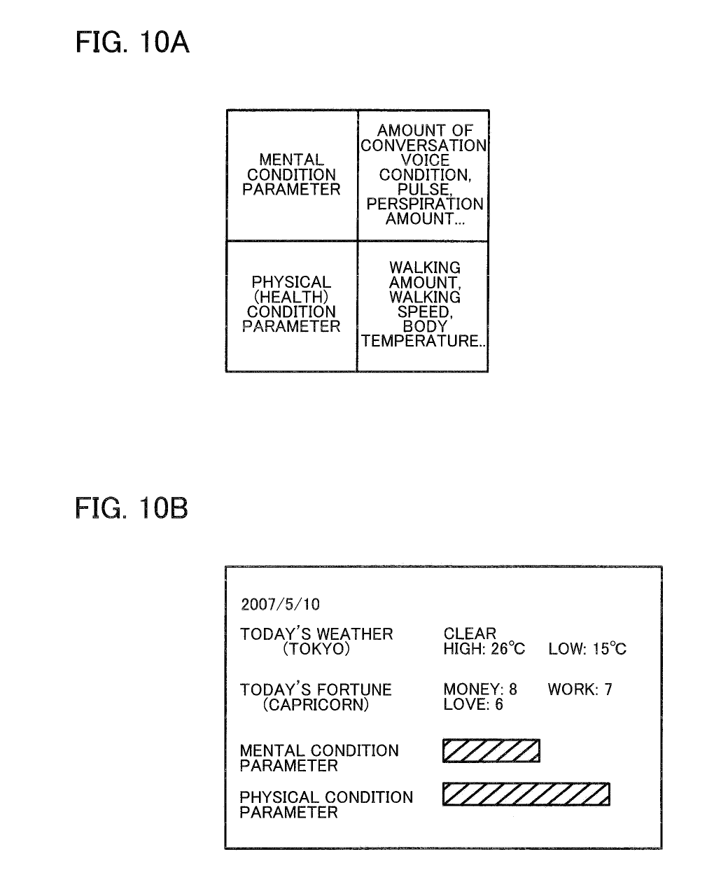

In FIG. 10A, mental condition parameters of the user are calculated by a given expression based on the measured values (e.g., amount of conversation, voice condition, pulse count, and amount of perspiration) indicated by the sensor information, for example. For example, the mental condition parameter increases (i.e., the user has a good mental condition) as the amount of conversation increases. Physical condition (health condition) parameters (exercise quantity parameters) are calculated by a given expression based on the measured values (e.g., walking amount, walking rate, and body temperature) indicated by the sensor information. For example, the physical condition parameter increases (i.e., the user has a good physical condition) as the walking amount increases.

As shown in FIG. 10B, the mental condition parameters and the physical condition parameters (condition parameters in a broad sense) may be visualized by utilizing a bar chart or the like, and displayed on the wearable display or the home display. The robot that operates in the home environment may be controlled to appreciate the pains the user has taken, encourage the user, or give the user advice based on the mental condition parameters and the physical condition parameters that have been updated in the mobile environment.

According to this embodiment, the user historical information (i.e., at least one of the behavior history, condition history, and environment history of the user) is acquired as the user information. The presentation information presented to the user by the robot is determined based on the acquired user historical information.

7. Conversation Between Robots Based on Scenario

A specific example of a case where a conversation between robots based on a scenario is presented to the user as the presentation information is described below.

7.1 Configuration

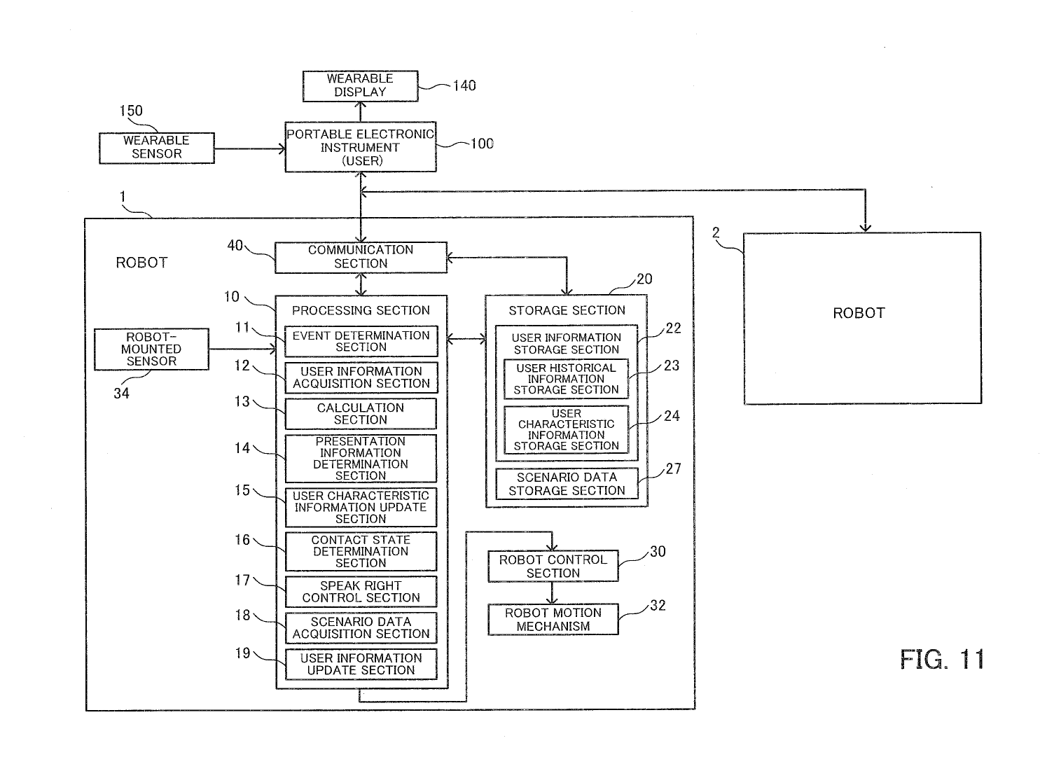

FIG. 11 shows a detailed system configuration example according to this embodiment. FIG. 11 differs from FIG. 2 etc. in that the processing section 10 further includes an event determination section 11, a contact state determination section 16, a speak right control section 17, a scenario data acquisition section 18, and a user information update section 19. FIG. 11 also differs from FIG. 2 etc. in that the storage section 20 includes a scenario data storage section 27.

The event determination section 11 determines occurrence of various events. Specifically, the event determination section 11 determines occurrence of a robot available event that indicates that the user whose user information has been updated in the mobile subsystem or the car subsystem can utilize the robot of the home subsystem. For example, the event determination section 11 determines that a robot available event has occurred when the user has approached (moved to) the place (home) where the robot is situated. When information is transferred via wireless communication, the event determination section 11 may determine occurrence of a robot available event by detecting the radio signal strength. Alternatively, the event determination section 11 may determine that a robot available event has occurred when the portable electronic instrument has been connected to the cradle. When the robot available event has occurred, the robots 1 and 2 are activated, and the user information is downloaded to the user information storage section 22 and the like.

The scenario data storage section 27 stores scenario data that includes a plurality of phrases as the presentation information. The presentation information determination section 14 determines the phrase spoken by the robot based on the scenario data. The robot control section 30 then causes the robot to speak the phrase determined by the presentation information determination section 14.

Specifically, the scenario data storage section 27 stores scenario data in which a plurality of phrases are linked by a branched structure. The presentation information determination section 14 determines the presentation information that is subsequently presented to the user by the robot based on the reaction of the user to the phrase that has been spoken by the robot. More specifically, when the user has made a given reaction (e.g., no reaction) to the phrase that has been spoken by the robot based on first scenario data (e.g., baseball topic), the presentation information determination section 14 selects second scenario data (e.g., a topic other than baseball) that is different from the first scenario data, and determines the phrase that is subsequently spoken by the robot based on the second scenario data.

The contact state determination section 16 determines a contact state on a sensing surface of the robot (described later). The presentation information determination section 14 determines whether the user has stroked or hit the robot as a reaction to the phrase spoken by the robot (presentation information presented by the robot) based on the determination result of the contact state determination section 16. The presentation information determination section 14 then determines the phrase (presentation information) that is subsequently spoken by the robot.

The contact state determination section 16 determines the contact state on the sensing surface based on output data obtained by performing a calculation process on an output signal (sensor signal) from a microphone (sound sensor) provided under the sensing surface (robot). In this case, the output data is a signal strength (signal strength data), for example. The contact state determination section 16 may compare the signal strength indicated by the output data with a given threshold value to determine whether the user has stroked or hit the robot.

The speak right control section 17 determines whether to give the next phrase speak right (initiative) to the robot 1 or the robot 2 based on the reaction (e.g., stroke, hit, or silence) of the user to the phrase spoken by the robot. Specifically, the speak right control section 17 determines the robot to which the next phrase speak right (initiative) is given, based on whether the user has made a positive or negative reaction to the phrase spoken by the robot 1 or the robot 2. For example, the speak right control section 17 gives the next phrase speak right (initiative) to the robot for which the user has made a positive reaction, or the robot for which the user has not made a negative reaction. The speak right control process may be implemented by utilizing a speak right flag or the like that indicates that the speak right is given to the robot 1 or the robot 2.

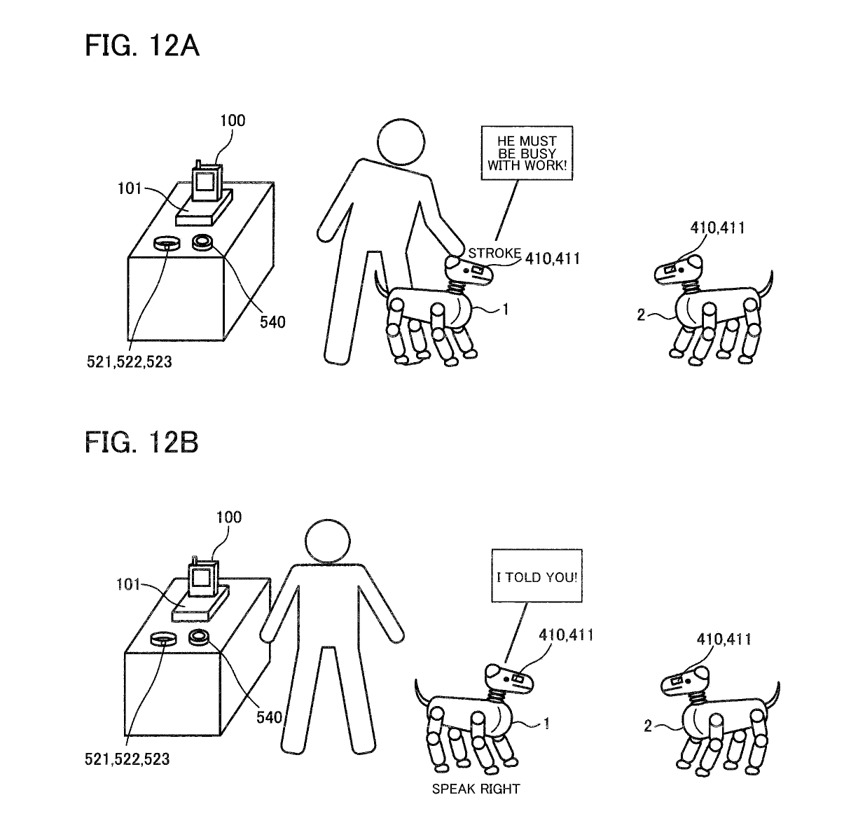

In FIG. 12A, when the robot 1 has spoken a phrase “He must be busy with work!”, the user strokes the robot 1 on the head (i.e., positive response). In this case, the next speak right is given to the robot 1 that has been stroked on the head (for which a positive response was made), as shown in FIG. 12B. Therefore, the robot 1 to which the speak right is given speaks a phrase “I told you!”. Specifically, since the robots 1 and 2 speak alternately in principle, for example, the next speak right should be given to the robot 2 in FIG. 12B. However, the next speak right is given to the robot 1 that has been stroked on the head by the user in FIG. 12B.

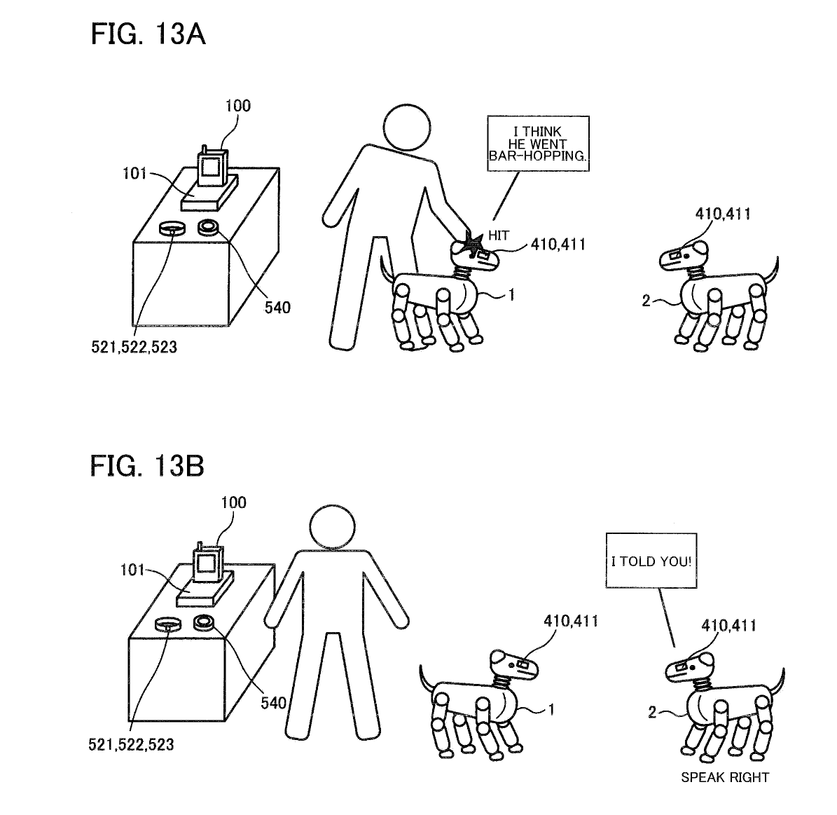

In FIG. 13A, when the robot 1 has spoken a phrase “I think he went bar-hopping”, the user hits the robot 1 on the head (i.e., negative response). In this case, the next speak right is given to the robot 2 that is not hit on the head (for which a negative response was not made), as shown in FIG. 13B. Therefore, the robot 2 to which the speak right is given speaks a phrase “I told you!”.

For example, when the robots 1 and 2 necessarily speak alternately, the conversation between the robots 1 and 2 may be monotonous so that the user may lose interest in the conversation between the robots 1 and 2.

However, since the speak right is given variously depending on the reaction of the user when using the speak right control method shown in FIGS. 12A to 13B, a situation in which the conversation between the robots becomes monotonous can be prevented, so that the user rarely loses interest in the conversation between the robots.

The scenario data acquisition section 18 acquires scenario data selected from a plurality of pieces of scenario data based on the user information.

Specifically, M (N>M≧1) pieces of scenario data selected from N pieces of scenario data based on the user information are downloaded to the scenario data storage section 27 through a network (not shown). For example, the scenario data is directly downloaded to the scenario data storage section 27 of the robot 1 from the external server 300, or downloaded to the scenario data storage section 27 from the external server 300 through the home server 200. In the configuration shown in FIG. 7, the scenario data is downloaded to the scenario data storage section (presentation information storage section 226) of the home server 200 from the external server 300.

The scenario data acquisition section 18 reads one of the M pieces of scenario data downloaded to the scenario data storage section 27 from the scenario data storage section 27 to acquire the scenario data used for a conversation between the robots, for example.

In this case, the scenario data acquired by the scenario data acquisition section 18 may be selected based on at least one of the current date information, current place information about the user, current behavior information about the user, and current occasion information about the user. Specifically, the scenario data acquired may be selected based on the real-time user information. Alternatively, the scenario data may be selected based on at least one of the behavior historical information and the condition historical information about the user. Specifically, the scenario data acquired may be selected based on the user historical information from past to present instead of the real-time user information.

It is possible to cause the robots to have a conversation based on the scenario data that is appropriate for the current date and the past or current condition, place, etc. of the user by selecting the scenario data based on the user information or the user historical information.

The user characteristic information update section 15 updates the user characteristic information based on the reaction of the user to the phrase spoken by the robot. The scenario data acquisition section 18 may acquire scenario data selected based on the user characteristic information. This makes it possible to learn the favorite, taste, etc. of the user based on the reaction of the user to update the user characteristic information, and select and use the scenario data that is appropriate for the favorite, taste, etc. of the user.

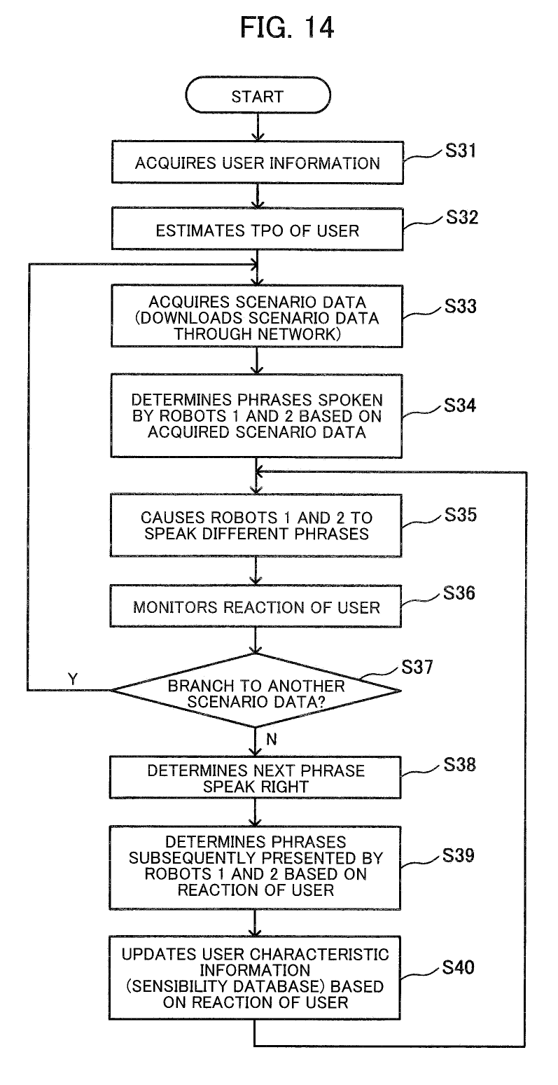

A detailed operation according to this embodiment is described below using a flowchart shown in FIG. 14.

The user information is acquired based on the sensor information (step S31). The TPO of the user is then estimated (step S32).

The scenario data is acquired based on the user information and the TPO (step S33). Specifically, the scenario data that is appropriate for the user information and the like is downloaded through the network.

The phrases spoken by the robots 1 and 2 are determined based on the acquired scenario data (step S34). The robot control process that causes the robots 1 and 2 to speak different phrases is performed (step S35).

The reaction of the user to the phrases spoken by the robots 1 and 2 is monitored (step S36). Whether or not to cause a branch to another scenario data is determined (step S37). When a branch to another scenario data is necessary, the step S33 is performed again. When a branch to another scenario data is unnecessary, whether to give the next phrase speak right to the robot 1 or the robot 2 is determined by the method shown in FIGS. 12A to 13B (step S38). The phrases subsequently spoken by the robots 1 and 2 are determined based on the reaction of the user (step S39). The user characteristic information (sensibility database) is updated based on the reaction of the user (step S40).

7.2 Specific Example of Scenario

A specific example of the scenario data and the scenario data selection method used in this embodiment is described below.

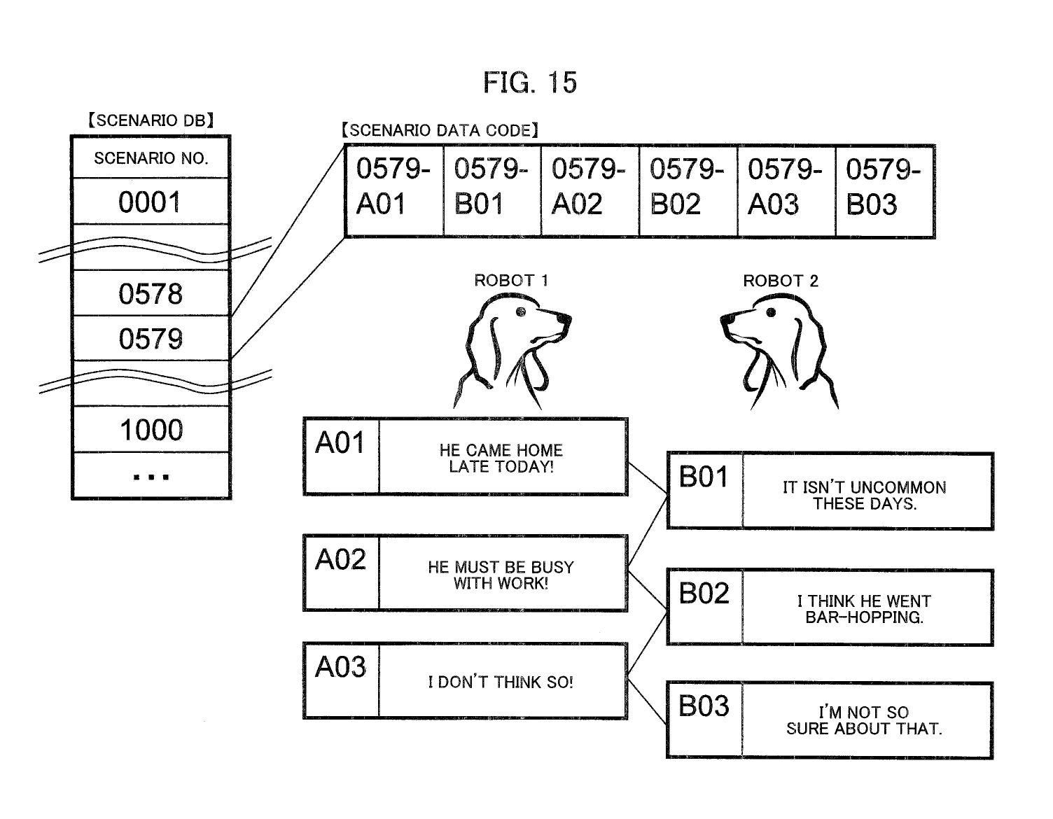

As shown in FIG. 15, a scenario number is assigned to each piece of scenario data stored in the scenario database. The scenario data specified by the scenario number includes a plurality of scenario data codes, and each phrase (text data) is designated by the scenario data code.

In FIG. 15, since it has been determined that the user has returned home later than usual based on the user information, the scenario data having a scenario number of 0579 is selected, for example. The scenario data having a scenario number of 0579 includes scenario data codes A01, B01, A02, B02, A03, and B03. The scenario data codes A01, A02, and A03 indicate phrases sequentially spoken by the robot 1, and the scenario data codes B01, B02, and B03 indicate phrases sequentially spoken by the robot 2. The conversation between the robots 1 and 2 corresponding to the user information described with reference to FIGS. 3A to 3C is implemented by utilizing the scenario data.

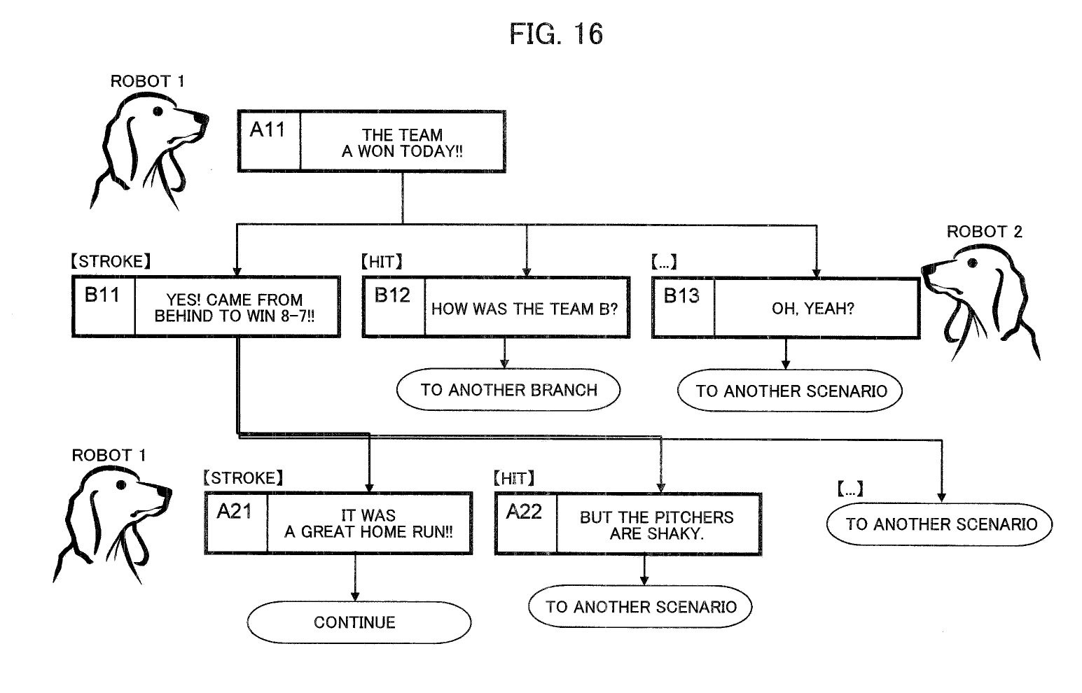

FIG. 16 shows an example of a scenario branch based on the reaction (behavior) (e.g., “stroke”, “hit”, and “no reaction”) of the user.

For example, the robot 1 speaks “The team A won today!!”. When the user who has listened to the phrase has stroked the robot 1, the user is estimated to be a fan of the baseball team A. In this case, the robot 2 speaks “Yes! Came from behind to win 8-7!!”. When the user who has listened to the phrase has stroked the robot 2, the user is estimated to be satisfied with the way that the team A won. In this case, the robot 1 speaks “It was a great home run!!”. When the user has hit the robot 2, the user is estimated to be not satisfied with the way that the team A won. In this case, the robot 1 speaks “But the pitchers are shaky”. When the user has made no reaction, a branch to another scenario occurs.

When the user who has listened to the phrase “The team A won today!!” spoken by the robot 1 has hit the robot 1, it is estimated that the user is not a fan of the baseball team A. In this case, the robot 2 speaks “How was the team B?” (i.e., changes the subject to the team B from the team A). A branch to another baseball scenario then occurs.

When the user has made no reaction, it is estimated that the user is not interested in baseball. In this case, the robot 2 speaks “Oh, yeah?”, and a branch to another scenario concerning a subject other than baseball occurs.

In FIG. 16, the phrase that is subsequently spoken by the robot is thus determined based on the reaction of the user to the phrase that has been spoken by the robot. A user's favorite baseball team or the like can be determined by detecting the reaction (e.g., stroke or hit) of the user so that the user characteristic information can be updated.

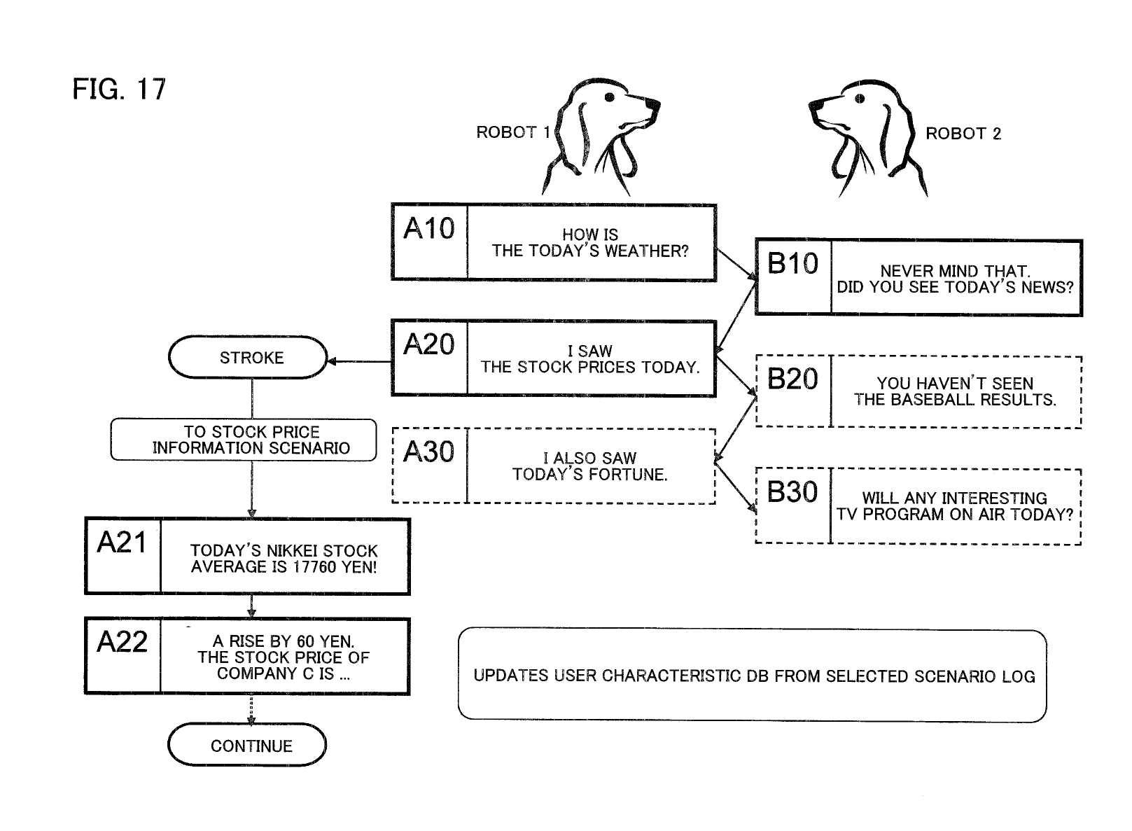

FIG. 17 shows an example of scenario selection and user characteristic information (database) update based on the reaction (e.g., “stroke”) of the user.

The robot 1 speaks “How is the today's weather?”. The robot 2 then speaks “Never mind that. Did you see today's news?”. The robot 1 then speaks “I saw the stock prices today”. When the user who has listened to the phrase has stroked the robot 1, it is estimated that the user is interested in stock topics. In this case, a branch to a stock price information scenario occurs, and the robot 2 speaks “Today's Nikkei Stock Average is 17760 yen” and “A rise by 60 yen. The stock price of company C is . . . ”.

In this embodiment, the user characteristic information database is updated based on a scenario log selected based on the reaction of the user. Specifically, it is estimated that the user is interested in stock topics based on the reaction of the user, and information that indicates that one of the favorites and taste of the user is stocks is registered in the database (i.e., learning). This allows a stock-related scenario to be selected with high probability when subsequently selecting the scenario data so that a topic that is appropriate for the favorite and the taste of the user can be provided.

Specifically, it is undesirable to inquire of the user about his favorite and taste by means of a questionnaire or the like since such a method troubles the user.

The method shown in FIG. 17 has an advantage in that the favorite and the taste of the user can be automatically determined and collected based on the reaction of the user to the conversation between the robots without troubling the user.

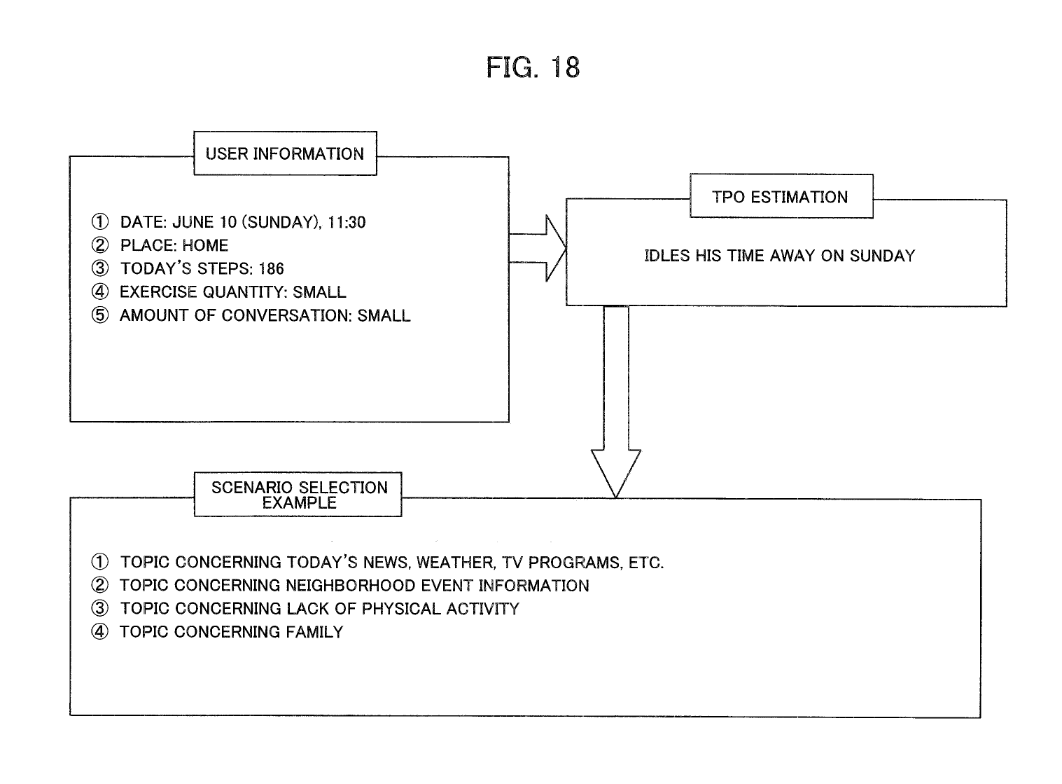

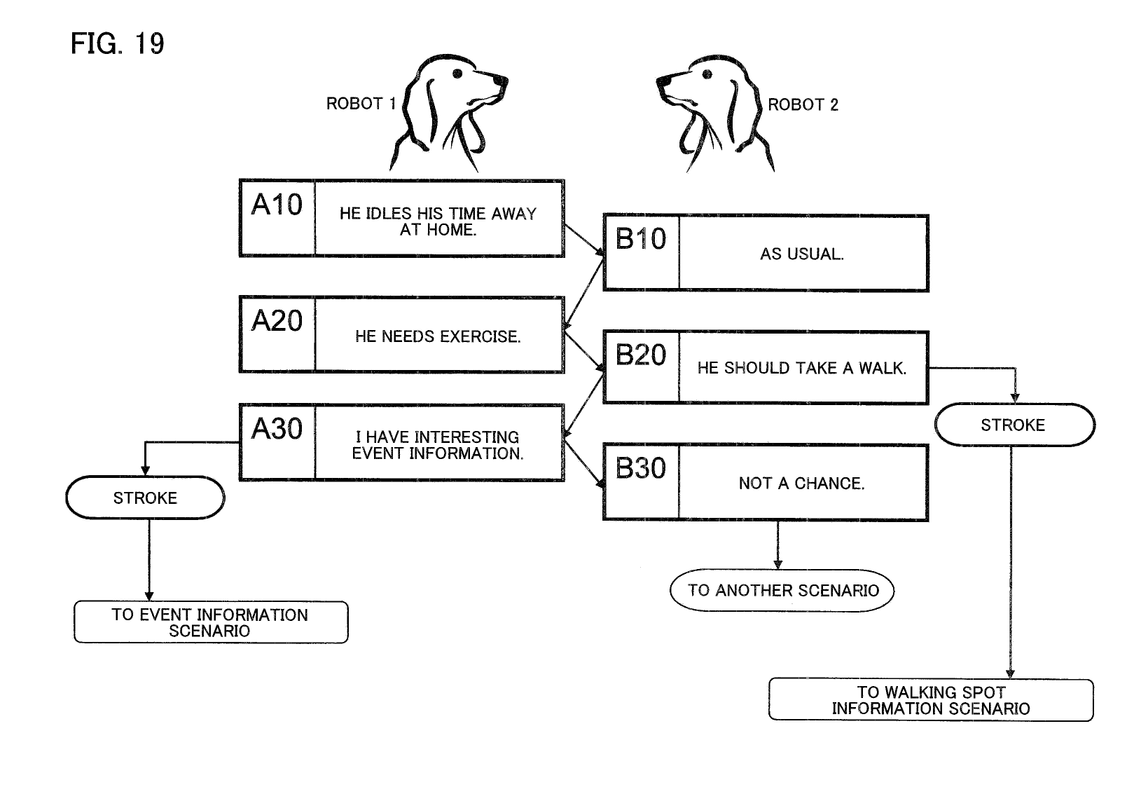

FIGS. 18 and 19 show examples of scenario selection based on real-time user information.

In FIG. 18, “Current date: June 10 (Sunday), 11:30”, “Current place: home”, “Today's steps: 186”, “Current exercise quantity: small”, and “Current amount of conversation: small” are acquired as the user information. The user information is acquired based on the sensor information from the wearable sensor 150 and the like.

The TPO of the user is estimated to be “Idles his time away on Sunday” based on the acquired user information. In this case, scenarios (scenario candidates) such as “Topic concerning today's news, weather, TV programs, etc.”, “Topic concerning neighborhood event information”, “Topic concerning lack of physical activity”, and “Topic concerning family” are selected. In FIG. 18, the scenarios (scenario data) are selected based on the current date information, the current place information about the user, the current behavior information about the user, and the current occasion information about the user.

As shown in FIG. 19, the robots 1 and 2 have a conversation such as “He idles his time away in home”, “As usual”, “He needs exercise”, “He should take a walk”, “I have interesting event information”, and “Not a chance” based on the selected scenario. Therefore, the user can be indirectly notified of his current behavior, condition, etc. by listening to the conversation between the robots 1 and 2. This makes it possible to implement an inspiring ubiquitous service that appeals to the user's mind to prompt the user to become aware of something for further personal growth, instead of a convenience provision service that unilaterally presents information to the user.

In FIG. 19, when the user has stroked the robot 1 that has spoken the phrase “I have interesting event information”, it is estimated that the user is interested in event information. In this case, the event information scenario is selected from the scenario candidates shown in FIG. 18, and a branch to the event information scenario occurs. When the user has stroked the robot 2 that has spoken the phrase “He should take a walk”, it is estimated that the user is interested in a walk. In this case, a branch to the walking spot information scenario occurs.

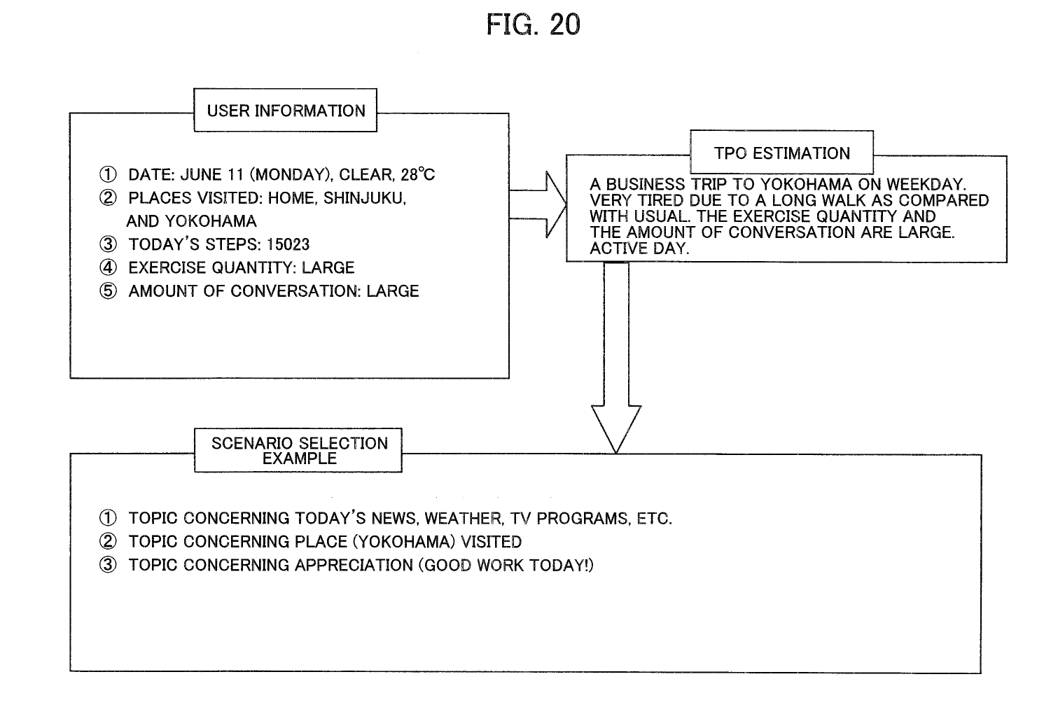

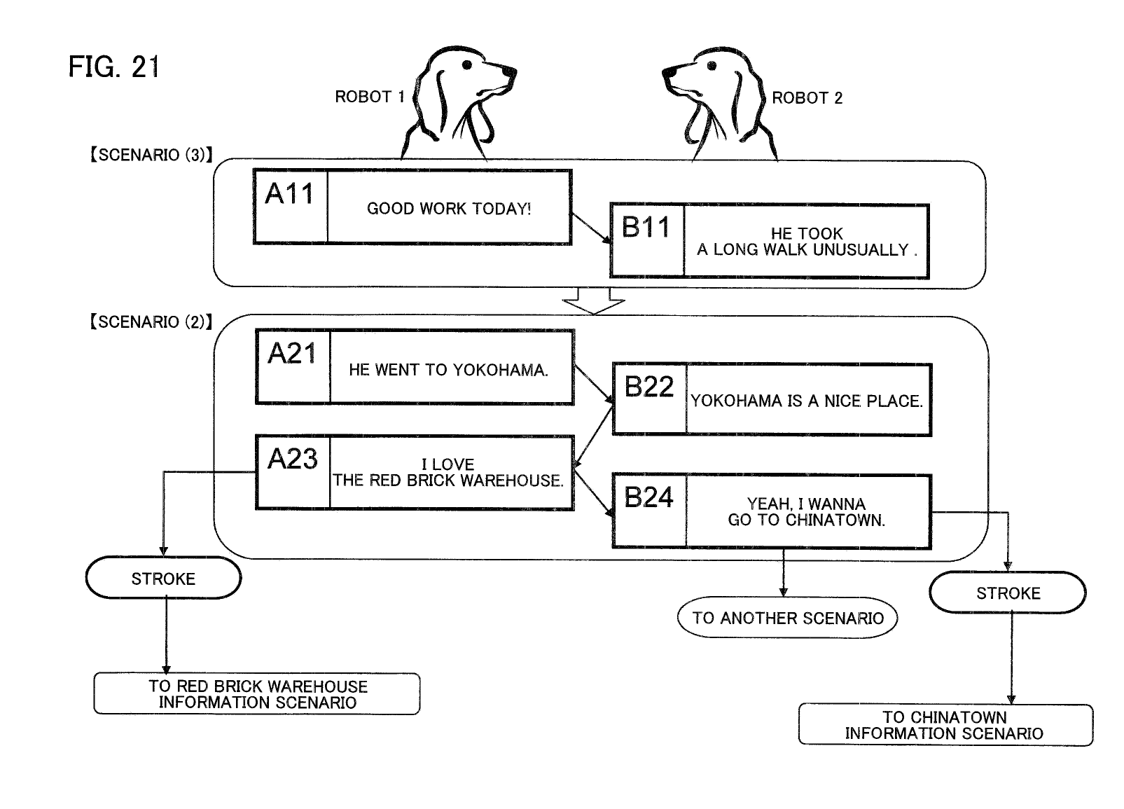

FIGS. 20 and 21 show examples of scenario selection based on the user historical information (information accumulated during a day).

In FIG. 20, “Date: June 11 (Monday), fine, 28° C.”, “Places visited: home, Shinjuku, and Yokohama”, “Today's steps: 15023”, “Today's exercise quantity: large”, and “Today's amount of conversation: large” are acquired as the user historical information. The user historical information is acquired based on the accumulation and history of the sensor information from the wearable sensor 150 and the like.

The TPO of the user is estimated to be “A business trip to Yokohama on weekday. Very tired due to a long walk as compared with usual. The exercise quantity and the amount of conversation are large. Active day” based on the acquired user historical information. In this case, scenarios (scenario candidates) such as “Topic concerning today's news, weather, TV programs, etc.”, “Topic concerning place (Yokohama) visited”, and “Topic concerning appreciation (Good work today!)” are selected. In FIG. 20, the scenarios (scenario data) are selected based on the behavior historical information, the condition historical information, etc. about the user.

As shown in FIG. 21, the robots 1 and 2 have a conversation such as “Good work today!”, “He took an usually long walk”, “He went to Yokohama”, “Yokohama is a nice place”, “I love the red brick warehouse”, and “Yeah, I wanna go to Chinatown” based on the selected scenario. Therefore, the user can be indirectly notified of his behavior history and condition history during the day by listening to the conversation between the robots 1 and 2. This makes it possible to implement an inspiring ubiquitous service that prompts the user to become aware of his behavior history etc.

In FIG. 21, when the user has stroked the robot 1 that has spoken the phrase “I love the red brick warehouse”, it is estimated that the user is interested in the red brick warehouse. In this case, a branch to the red brick warehouse information scenario occurs. Likewise, when the user has stroked the robot 2 that has spoken the phrase “Yeah, I wanna go to Chinatown”, a branch to the Chinatown information scenario occurs.

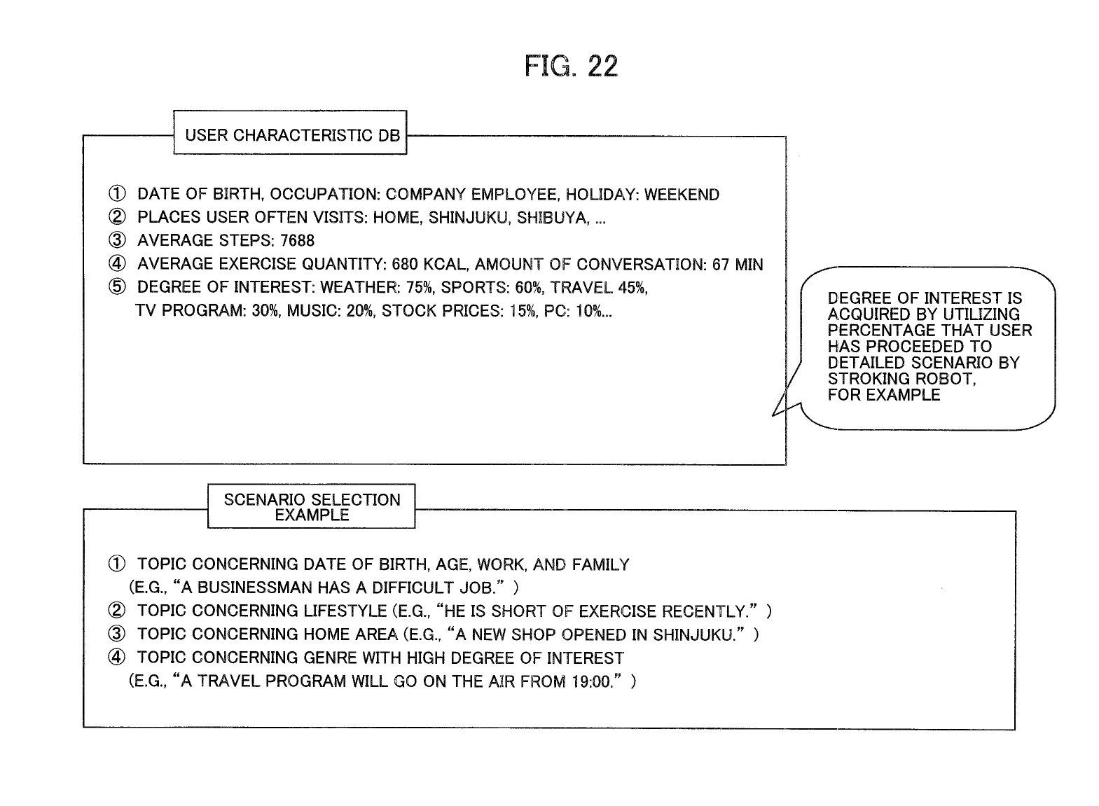

FIG. 22 shows an example of scenario selection based on the user characteristic information database.

In FIG. 22, “Date of birth, occupation: company employee, holiday: weekend”, “Places the user often visits: Home, Shinjuku, Shibuya, . . . ”, “Average steps: 7688”, “Average exercise quantity: 680 kcal”, “Amount of conversation: 67 min”, and “Degree of interest: weather: 75%, sports: 60%, travel 45%, TV program: 30%, music: 20%, stock prices: 15%, PC: 10%” are acquired as the user characteristic information. The degree of interest is acquired by utilizing the percentage that the user has proceeded to a detailed scenario by stroking the robot, for example.

The scenarios such as “Topic concerning date of birth, age, work, and family (e.g., “A businessman has a difficult job”)”, “Topic concerning lifestyle (e.g., “He is short of exercise recently”)”, “Topic concerning home area (e.g., “A new shop opened in Shinjuku”)”, and “Topic concerning genre with high degree of interest (e.g., “A travel program will go on the air from 19:00”)” are selected based on the user characteristic information shown in FIG. 22. This makes it possible to select a scenario that matches the characteristics (sensibility) of the user.

8. Determination of Presentation Information Based on User Historical Information

The details of the presentation information determination process based on user historical information are described below. The following description illustrates the behaviors of the robots when the user who has gone out for a certain period has returned home and approached the robots (robots 1 and 2).

For example, a robot (home subsystem) available event occurs when the user has returned home or approached the robots. Specifically, when a situation in which the user has returned home has been detected by the GPS sensor of the wearable sensor or the door sensor or based on connection of the portable electronic instrument to the cradle, or a situation in which the user has approached the robots has been detected based on the radio signal strength of wireless communication or by the touch sensor of the robot, the event determination section 11 shown in FIG. 11 determines that a robot available event has occurred. Specifically, the event determination section 11 determines that a robot available event that indicates that the robots have become available has occurred.

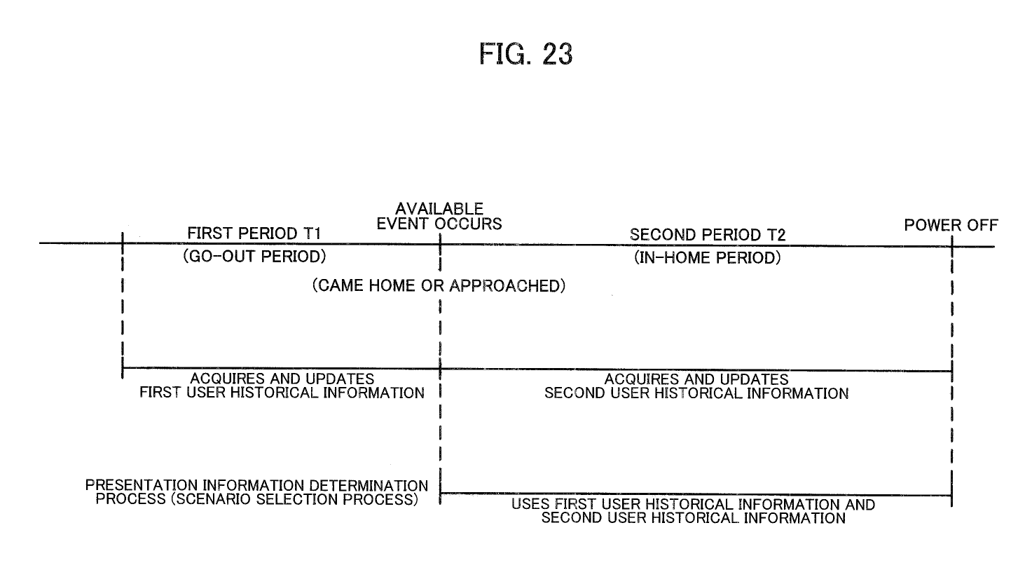

In FIG. 23, a go-out period (robot unavailable period of the robot or robot-user non-approach period) before the available event has occurred is referred to as a first period T1, and an in-home period (robot available period or robot-user approach period) after the available event has occurred is referred to as a second period T2, for example. The user historical information acquired (updated) in the first period T1 is referred to as first user historical information, and the user historical information acquired (updated) in the second period T2 is referred to as second user historical information.

The first user historical information may be acquired by measuring the behavior (e.g., walking, speech, or meal), the condition (e.g., tiredness, tension, hungry, mental condition, or physical condition), or the environment (e.g., place, brightness, or temperature) of the user in the first period T1 using the behavior sensor, the condition sensor, and the environment sensor of the wearable sensor 150 shown in FIG. 11. Specifically, the user information update section of the portable electronic instrument 100 updates the user historical information stored in the user information storage section of the portable electronic instrument 100 based on the sensor information from these sensors so that the first user historical information is acquired in the first period T1.

When the robot available event has occurred, the first user historical information updated in the first period T1 is transferred from the user information storage section of the portable electronic instrument 100 to the user information storage section 22 (user historical information storage section 23) of the robot 1 (robot 2). This makes it possible for the presentation information determination section 14 to determine the presentation information presented to the user by the robots 1 and 2 (select the scenario) based on the first user historical information transferred from the user information storage section.

The second user historical information may be acquired by measuring the behavior, the condition, or the environment of the user using the robot-mounted sensor 34 or other sensors (e.g., wearable sensor or home sensor) in the second period T2. Specifically, the user information update section 19 updates the user historical information stored in the user information storage section 22 based on the sensor information from these sensors so that the second user historical information is acquired in the second period T2.

As shown in FIG. 23, the presentation information determination section 14 determines the presentation information presented to the user by the robots 1 and 2 based on the first user historical information acquired in the first period T1 and the second user historical information acquired in the second period T2. Specifically, the presentation information determination section 14 determines the scenario used for a conversation between the robots 1 and 2 based on the first user historical information and the second user historical information. This makes it possible to provide the user with presentation information that takes account of the behavior etc. of the user in the go-out period and the behavior etc. of the user in the in-home period to prompt the user to become aware of his behavior etc. inside and outside the home, for example.

More specifically, the presentation information determination section 14 changes the weighting (weighting coefficient) of the first user historical information and the weighting of the second user historical information when determining the presentation information in the second period T2.

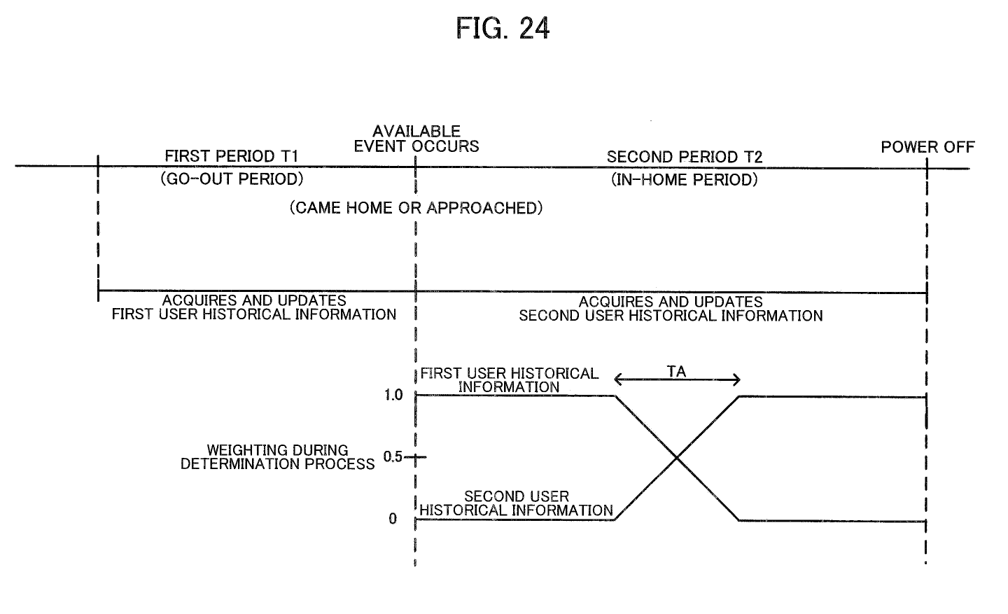

In FIG. 24, when an available event of the robots 1 and 2 has occurred (when the user has returned home or until a given period elapses after the user has returned home), the weighting of the first user historical information is higher than the weighting of the second user historical information during the determination process. For example, the weighting of the first user historical information is “1.0”, and the weighting of the second user historical information is “0”.

The weighting of the first user historical information decreases and the weighting of the second user historical information increases in a weighting change period TA. The weighting of the second user historical information is higher than the weighting of the first user historical information after the weighting change period TA. For example, the weighting of the first user historical information is “0”, and the weighting of the second user historical information is “1.0”.

In FIG. 24, the weighting of the first user historical information is increased during the determination process while decreasing the weighting of the second user historical information when an available event has occurred, and the weighting of the first user historical information is then decreased while increasing the weighting of the second user historical information. Specifically, in the second period T2, the weighting of the first user historical information during the presentation information determination process is decreased with the passage of time while increasing the weighting of the second user historical information with the passage of time.

Therefore, a topic concerning the behavior etc. of the user in the first period T1 (e.g., go-out period) is provided by the robots 1 and 2 in the first half of the second period T1. The robots 1 and 2 then provide a topic concerning the behavior etc. of the user at home. This makes it possible to provide a timely topic corresponding to the behavior, the condition, etc. of the user.

Note that the weighting change method is not limited to the method shown in FIG. 24. For example, the weighting of the second user historical information may be set to be higher than the weighting of the first user historical information in the first half, and the weighting of the first user historical information may then be set to be higher than the weighting of the second user historical information. Alternatively, the presentation information may be determined taking account of the user historical information before the first period T1. A change in weighting may be programmed in advance in the robots 1 and 2 and the like, or the user may arbitrarily change the weighting as he likes.

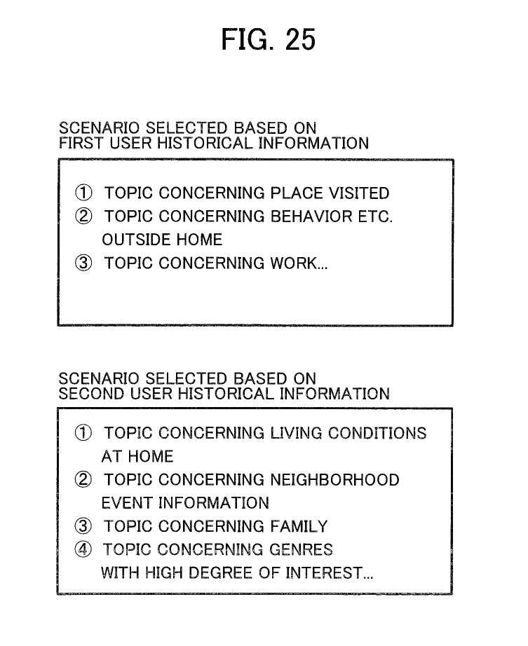

FIG. 25 shows a specific example of the user historical information weighting method. Examples of the weighting of the user historical information during the determination process include the selection probability of the scenario selected based on the user historical information. Specifically, when increasing the weighting of the first user historical information, the scenario is selected based on the first user historical information rather than the second user historical information. Specifically, the selection probability of the scenario based on the first user historical information is increased. On the other hand, when increasing the weighting of the second user historical information, the scenario is selected based on the second user historical information rather than the first user historical information. Specifically, the selection probability of the scenario based on the second user historical information is increased.

As shown in FIG. 25, examples of the scenario selected based on the first user historical information include a topic concerning a place visited, a topic concerning the behavior etc. outside the home (e.g., Good work today!), and a topic concerning work (see FIG. 20). Examples of the scenario selected based on the second user historical information include a topic concerning living conditions at home (e.g., lack of physical activity), a topic concerning neighborhood event information, a topic concerning family, a topic concerning genres with a high degree of interest, and the like (see FIG. 18).

In FIG. 24, since the weighting of the first user historical information is higher than the weighting of the second user historical information in the first half of the second period T2, the selection probability of the scenario based on the first user historical information increases. Therefore, the robots 1 and 2 have a conversation concerning the place which the user visited in the first half of the second period T2, for example. On the other hand, since the weighting of the second user historical information is higher than the weighting of the first user historical information in the second half of the second period T2, the selection probability of the scenario based on the second user historical information increases. Therefore, the robots 1 and 2 have a conversation concerning living conditions at home (e.g., “He needs exercise”) in the second half of the second period T2, for example. This makes it possible to change the topic of the scenario corresponding to a change in environment (returning home) of the user so that a more natural conversation between the robots 1 and 2 can be implemented.

9. Contact State Determination

A specific example of a method of determining an operation (e.g., hitting or stroking the robot) is described below.

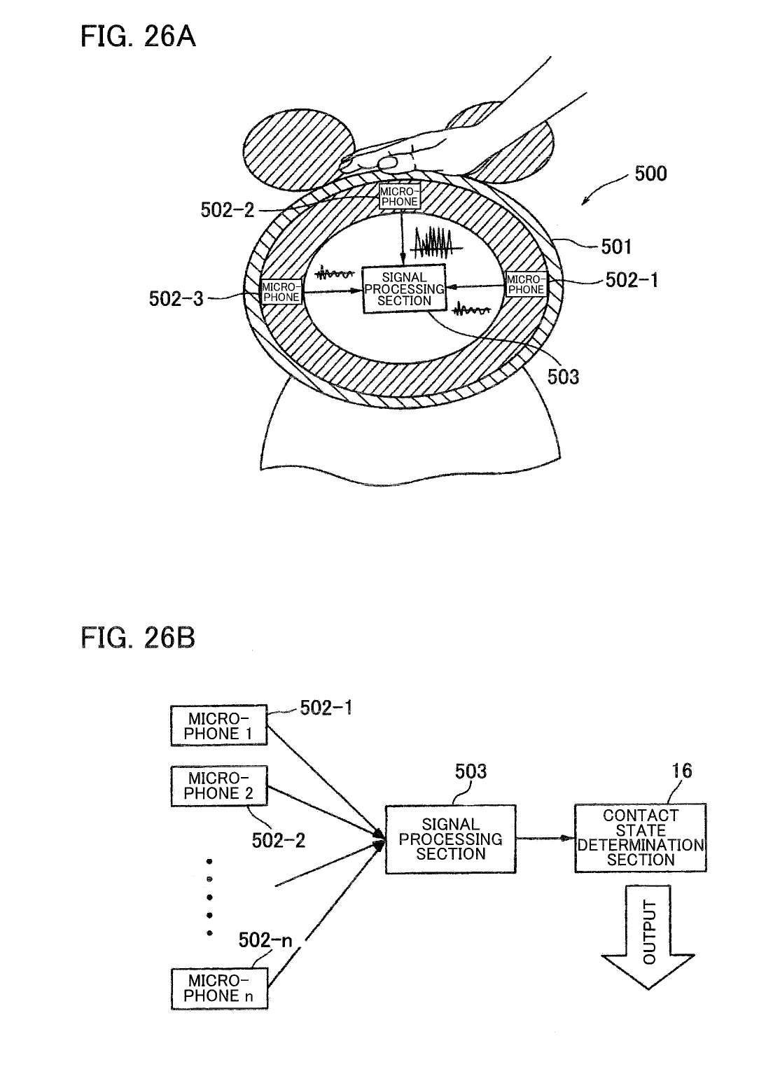

FIG. 26A shows an example of a stuffed toy-type robot 500. The surface of the robot 500 functions as a sensing surface 501. The robot 500 includes microphones 502-1, 502-2, and 502-3 that are provided under the sensing surface 501. The robot 500 also includes a signal processing section 503 that processes output signals from the microphones 502-1, 502-2, and 502-3 and outputs output data.

As shown in FIG. 26B (functional block diagram), the output signals from the microphones 502-1, 502-2, and 502-3 are input to the signal processing section 503. The signal processing section 503 processes/converts the analog output signals by noise removal, signal amplification, and the like. The signal processing section 503 calculates the signal strength and the like, and outputs digital output data. The contact state determination section 16 performs a threshold value comparison process, a contact state classification process, and the like.

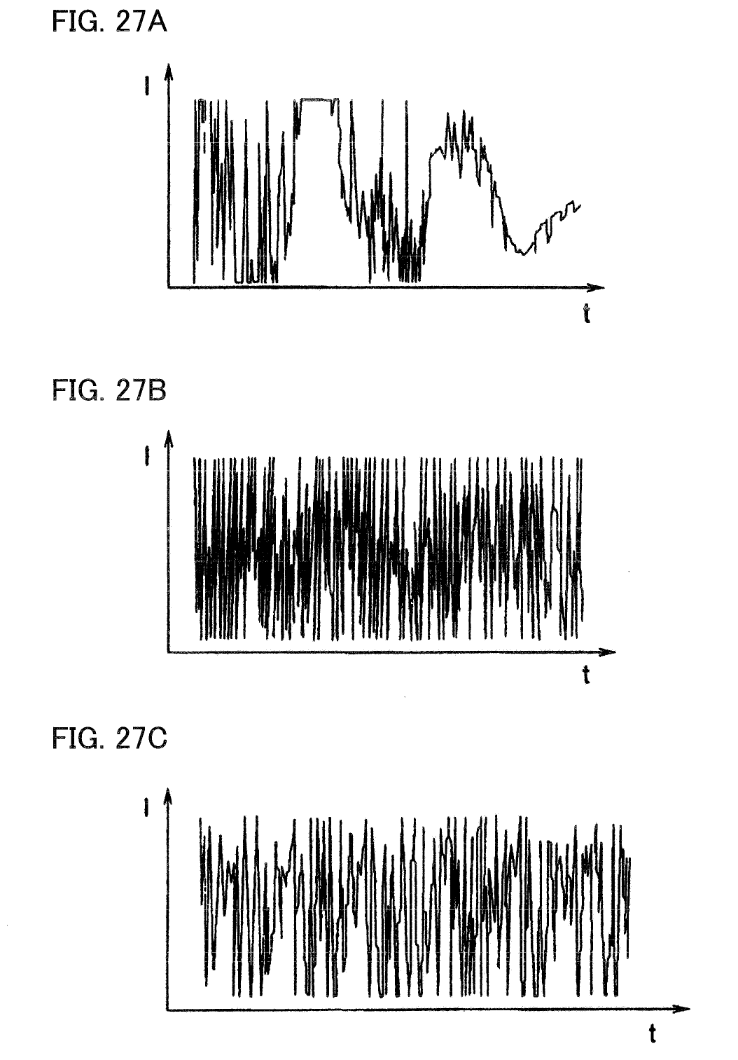

FIGS. 27A, 27B, and 27C show voice waveform examples when hitting the sensing surface 501, stroking the sensing surface 501, and speaking into the microphones. The horizontal axis indicates the time, and the vertical axis indicates the signal strength.

A high signal strength is obtained when hitting the sensing surface 501 (FIG. 27A) and stroking the sensing surface 501 (FIG. 27B). A high signal strength temporarily occurs when hitting the sensing surface 501, and successively occurs when stroking the sensing surface 501. As shown in FIG. 27C, the signal strength of the waveform when strongly pronouncing a word (e.g., “aaa”) is lower than that when hitting the sensing surface 501 (FIG. 27A) or stroking the sensing surface 501 (FIG. 27B).

A hit state, a stroked state, and another state can be detected by providing a threshold value that utilizes such a difference. A position where the strongest signal is generated can be detected to be a hit area or a stroked area by utilizing the microphones 502-1, 502-2, and 502-3.

Specifically, the microphones 502-1, 502-2, and 502-3 provided in the robot 500 detect sound that propagate inside the robot 500 when the hand of the user or the like has come in contact with the sensing surface 501 of the robot 500, and convert the detected sound into an electrical signal.

The signal processing section 503 subjects the output signals (sound signals) from the microphones 502-1, 502-2, and 502-3 to noise removal, signal amplification, and A/D conversion, and outputs output data. The signal strength can be calculated by converting the output data into an absolute value, and storing (accumulating) the value for a given period of time. The calculated signal strength is compared with a threshold value TH. If the signal strength exceeds the threshold value TH, it is determined that a contact state has been detected, and a contact state detection count is incremented. The contact state detection process is repeated for a given period of time.

When the given period of time has elapsed, the contact state determination section 16 compares a condition set in advance with the contact state detection count to detect a stroked state or a hit state using the following condition, for example. Specifically, the contact state determination section 16 detects a stroked state or a hit state by utilizing a phenomenon in which the contact state detection count increases when stroking the sensing surface 501 since the contact state continues, but decreases when hitting the sensing surface 501.

Detected state (Detection count/maximum detection count)×100 (%)

Stroked state 25% or more

Hit state 10% or more and less than 25%

Non-detected state Less than 10%

This makes it possible to determine a hit state, a stroked state, and another state (non-detected state) by utilizing at least one microphone. Moreover, the contact area can be determined by providing a plurality of microphones and comparing the contact state detection count of each microphone.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The configurations and the operations of the robot control system and the robot are not limited to those described with reference to the above embodiments. Various modifications and variations may be made.

1. A robot control system that controls a robot, the robot control system comprising:
a user information acquisition section that acquires user information that is obtained based on sensor information from at least one of a behavior sensor that measures a behavior of a user, a condition sensor that measures a condition of the user, and an environment sensor that measures an environment of the user;
a presentation information determination section that determines presentation information that is presented to the user by the robot based on the acquired user information; and
a robot control section that controls the robot to present the presentation information to the user,
the presentation information determination section determining the presentation information that is presented to the user so that a first robot and a second robot present different types of presentation information based on the identical acquired user information.

2. The robot control system as defined in claim 1,
the first robot being set as a master, and the second robot being set as a slave; and
the presentation information determination section that is provided in the master-side first robot instructing the slave-side second robot to present the presentation information to the user.

3. The robot control system as defined in claim 2, further comprising:
a communication section that transmits instruction information from the master-side first robot to the slave-side second robot, the instruction information instructing presentation of the presentation information.

4. The robot control system as defined in claim 1,
the user information acquisition section acquiring user historical information as the user information, the user historical information being at least one of a behavior history, a condition history, and an environment history of the user; and
the presentation information determination section determining the presentation information that is presented to the user by the robot based on the acquired user historical information.

5. The robot control system as defined in claim 4, further comprising:
an event determination section that determines occurrence of an available event that indicates that the robot is available,
the presentation information determination section determining the presentation information presented to the user by the robot based on first user historical information acquired in a first period before the available event occurs and second user historical information acquired in a second period after the available event has occurred.

6. The robot control system as defined in claim 5,
the presentation information determination section changing weighting of the first user historical information and weighting of the second user historical information when determining the presentation information in the second period.

7. The robot control system as defined in claim 6,
the presentation information determination section increasing the weighting of the first user historical information while decreasing the weighting of the second user historical information when determining the presentation information when the available event has occurred, and then decreasing the weighting of the first user historical information while increasing the weighting of the second user historical information.

8. The robot control system as defined in claim 4,
the user historical information being information that is updated based on sensor information from a wearable sensor of the user.

9. The robot control system as defined in claim 1,
the presentation information determination section determining the presentation information that is subsequently presented to the user by the robot based on a reaction of the user to the presentation information that has been presented by the robot.

10. The robot control system as defined in claim 9, further comprising:
a user characteristic information storage section that stores user characteristic information; and
a user characteristic information update section that updates the user characteristic information based on the reaction of the user to the presentation information presented by the robot.

11. The robot control system as defined in claim 9, further comprising:
a contact state determination section that determines a contact state on a sensing surface of the robot,
the presentation information determination section determining whether the user has stroked or hit the robot as the reaction of the user to the presentation information presented by the robot based on the determination result of the contact state determination section, and determining the presentation information that is subsequently presented to the user.

12. The robot control system as defined in claim 11,
the contact state determination section determining the contact state on the sensing surface based on output data obtained by performing a calculation process on an output signal from a microphone provided under the sensing surface.

13. The robot control system as defined in claim 12,
the output data being a signal strength; and
the contact state determination section comparing the signal strength with a given threshold value to determine whether the user has stroked or hit the robot.

14. The robot control system as defined in claim 1, further comprising:
a scenario data storage section that stores scenario data that includes a plurality of phrases as the presentation information,
the presentation information determination section determining a phrase spoken to the user by the robot based on the scenario data; and
the robot control section causing the robot to speak the determined phrase.

15. The robot control system as defined in claim 14,
the scenario data storage section storing the scenario data in which a plurality of phrases are linked by a branched structure; and
the presentation information determination section determining a phrase that is subsequently spoken by the robot based on a reaction of the user to the phrase that has been spoken by the robot.

16. The robot control system as defined in claim 15,
the presentation information determination section selecting second scenario data that is different from first scenario data when the user has made a given reaction to a phrase that has been spoken by the robot based on the first scenario data, and determining the phrase that is subsequently spoken by the robot based on the second scenario data.

17. The robot control system as defined in claim 14, further comprising:
a speak right control section that determines whether to give a next phrase speak right to the first robot or the second robot based on a reaction of the user to the phrase spoken by the robot.

18. The robot control system as defined in claim 17,
the speak right control section determining a robot to which the next phrase speak right is given, based on whether the user has made a positive reaction or a negative reaction to a phrase spoken by the first robot or the second robot.

19. The robot control system as defined in claim 14, further comprising:
a scenario data acquisition section that acquires scenario data selected from a plurality of pieces of scenario data based on the user information.

20. The robot control system as defined in claim 19,
the scenario data acquisition section downloading the scenario data selected based on the user information through a network; and
the presentation information determination section determining a phrase spoken to the user by the robot based on the scenario data downloaded through the network.

21. The robot control system as defined in claim 19,
the scenario data acquisition section acquiring scenario data selected based on at least one of current date information, current place information about the user, current behavior information about the user, and current occasion information about the user; and
the presentation information determination section determining the phrase spoken to the user by the robot based on the scenario data selected based on at least one of the current date information, the current place information about the user, the current behavior information about the user, and the current occasion information about the user.

22. The robot control system as defined in claim 19,
the scenario data acquisition section acquiring scenario data selected based on at least one of behavior historical information about the user and condition historical information about the user; and
the presentation information determination section determining the phrase spoken by the robot based on the scenario data selected based on at least one of the behavior historical information about the user and the condition historical information about the user.

23. The robot control system as defined in claim 19, further comprising:
a user characteristic information storage section that stores user characteristic information; and
a user characteristic information update section that updates the user characteristic information based on a reaction of the user to the phrase spoken by the robot,
the scenario data acquisition section acquiring scenario data selected based on the user characteristic information.

24. A robot comprising:
the robot control system as defined in claim 1; and
a robot motion mechanism that is a control target of the robot control system.

25. A robot control program, the program causing a computer to function as:
a user information acquisition section that acquires user information that is obtained based on sensor information from at least one of a behavior sensor that measures a behavior of a user, a condition sensor that measures a condition of the user, and an environment sensor that measures an environment of the user;
a presentation information determination section that determines presentation information that is presented to the user by the robot based on the acquired user information; and
a robot control section that controls the robot to present the presentation information to the user,
the presentation information determination section determining the presentation information that is presented to the user so that a first robot and a second robot present different types of presentation information based on the identical acquired user information.

26. A computer-readable information storage medium storing the program as defined in claim 25.
